(19) United States
(12) Patent Application Publication
(10) Pub. No.: US 2015/0274914 A1
(43) Pub. Date: Oct. 1, 2015

(54) RESIN PARTICLES AND METHOD FOR PRODUCING SAME

(71) Applicant: SANYO CHEMICAL INDUSTRIES, LTD., Kyoto (JP)

(72) Inventors: Masashi Minaki, Kyoto-shi (JP); Tsuyoshi Izumi, Kyoto-shi (JP); Yasuaki Ota, Kyoto-shi (JP)

(21) Appl. No.: 14/428,741

(22) PCT Filed: Sep. 17, 2013
(86) PCT No.: PCT/JP2013/074974

§ 371 Date: Mar. 17, 2015

(30) Foreign Application Priority Data
Sep. 18, 2012 (JP) 2012-203796

(51) Int. Cl. C08J 7/04

(52) U.S. Cl. CPC C08J 7/047; C08J 2367/02; C08J 2475/06

(57) ABSTRACT

Provided are resin particles which have excellent thermal bondability, excellent low-temperature fixability, excellent heat resistant storage stability and high bonding strength, and which provide a coating film that has high gloss and excellent water resistance. The resin particles are composed of resin particles (X), each of which has a shell layer (S) containing a crystalline polyurethane resin (B) on the surface of a core layer (Q) containing a crystalline resin (A). The maximum peak temperature (Ta) of the heat of fusion of the crystalline resin (A) is 40 to 70° C. and the maximum peak temperature (Tu) of the heat of fusion of the crystalline polyurethane resin (B) is 50 to 90° C.

### TECHNICAL FIELD

The present invention relates to a resin particle and a method for producing the same.

### BACKGROUND ART

As a resin particle having a small melting energy and excellent heat resistant storage stability, there is known a core-shell resin particle composed of a shell layer and a core layer (see Patent Document 1). However, when the resin particle of Patent Document 1 is used for an application of processing and treating a resin by a thermal adhesion system, the entire resin particles cannot be melted until the resin particle is heated at a high temperature for a long period and there has been a problem that such a core-shell resin particle does not have sufficient heat adhesion or thermal bondability. In order to improve the heat adhesion of a resin particle, proposed is a core-shell resin particle composed of a shell layer and a core layer, in which a sharp melt characteristic is imparted to the shell layer (see Patent Document 2). However, even the resin particle of Patent Document 2 does not have sufficient heat adhesion. There is therefore a need for developing a core-shell resin particle having excellent heat adhesion.

### PRIOR ART DOCUMENTS

### Patent Documents

Patent Document 1: JP-A-61-118758

Patent Document 2: JP-A-2010-47752

### SUMMARY OF THE INVENTION

### Problems to be Solved by the Invention

An object of the present invention is to provide a core-shell resin particle excellent in heat adhesion.

### Solutions to the Problems

As a result of earnest study for solving the above-described problem, the present inventors have accomplished the present invention.

That is, the present invention includes:

a resin particle (X) having a shell layer (S) containing a crystalline polyurethane resin (B) on the surface of a core layer (Q) containing a crystalline resin (A), wherein the maximum peak temperature (Ta) of the heat of fusion of the crystalline resin (A) is 40 to 70° C. and the maximum peak temperature (Tu) of the heat of fusion of the crystalline polyurethane resin (B) is 50 to 90° C.; and

a method for producing a resin particle (X) resulting from attachment of a resin particle (E) to the surface of a resin particle (G) containing a crystalline resin (A), the resin particle (X) being obtained by following a step of dispersing a solution (D) prepared by dissolving the crystalline resin (A) in an organic solvent (C) in a dispersion medium (F) containing the resin particle (E) containing a crystalline polyurethane resin (B), thereby obtaining a dispersion (DF), and then removing the organic solvent (C) and the dispersion medium (F) from the dispersion (DF), wherein the resin particle (X) is structured to have a shell layer (S) containing the crystalline polyurethane resin (B) on the surface of a core layer (Q) containing the crystalline resin (A), the maximum peak temperature (Ta) of the heat of fusion of the crystalline resin (A) is 40 to 70° C., and the maximum peak temperature (Tu) of the heat of fusion of the crystalline polyurethane resin (B) is 50 to 90° C.

### Advantages of the Invention

The resin particle of the present invention is excellent in heat adhesion, low-temperature fixability, and heat resistant storage stability and high in adhesion strength, and a coating film obtained from the resin particle is high in glossiness and the coating film is excellent in water resistance.

### MODE FOR CARRYING OUT THE INVENTION

The crystalline resin (A) for use in the present invention is a resin having a ratio (Tm/Ta) of 0.8 to 1.55 where the ratio is a ratio of the softening point of the resin (hereinafter abbreviated as Tm) to the maximum peak temperature of heat of fusion (hereinafter abbreviated as Ta), and having a clear endothermic peak in DSC. Tm and Ta can be measured by the following methods.

### <Method for Measuring Tm>

The measurement is performed by means of a flow tester at a load of 1.96 MPa. For example, by means of a Koka-type flow tester (e.g., “CFT-500D” [manufactured by Shimadzu Corporation]), 1 g of a measurement sample is heated at a temperature rising speed of 6° C./min, and at the same time, a load of 1.96 MPa is applied with a plunger to extrude the sample through a nozzle having a diameter of 1 mm and a length of 1 mm, during which “a lowering distance of the plunger (flow amount)” versus “temperature” is plotted in a graph. The temperature corresponding to ½ of the maximum value of the lowering distance of the plunger is read from the graph, and this temperature (temperature at which a half of the measurement sample is flown out) is determined as Tin.

### <Method for Measuring Maximum Peak Temperature of Heat of Fusion>

The measurement is performed by means of a differential scanning calorimeter (e.g., “DSC210” [manufactured by Seiko Instruments Inc.]). In the measurement, a resin sample prepared by melting at 130° C., cooling it from this temperature to 70° C. at a rate of 1.0° C./min, and cooling it from 70° C. to 10° C. at a rate of 0.5° C./min is cooled to 0° C. at a rate of 10° C./min and measured at a temperature rising speed of 20° C./min, and then the temperature corresponding to the maximum peak of endotherm is determined.

Specifically, as a pretreatment, (A) to be subjected to the measurement of Ta is melted at 130° C., then cooled from 1300C to 70° C. at a rate of 1.0° C./min, and then cooled from 70° C. to 10° C. at a rate of 0.5° C./min. Endothermic or exothermic change is measured by DSC by raising the temperature at a temperature rising speed of 20° C./min, and a graph of the “endo- or exotherm” versus the “temperature” is drawn, and the endothermic peak temperature within the range of 20 to 10000 observed at this time is determined as Ta′. When there are a plurality of peaks, the temperature of the peak at which the endotherm is greatest is determined as Ta′. Finally, the sample is stored for 6 hours at (Ta′−10°) C and then stored for 6 hours at (Ta′−15°) C.

Next, after cooling the (A) stored in the above-described manner to 0° C. at a temperature ramp-down rate of 10° C./min by means of DSC, the sample is heated at a temperature rising speed of 20° C./min to measure endothermic and exothermic changes, to thereby draw a graph of “endo- or exotherm” versus “temperature”. The temperature corresponding to the maximum peak of the endotherm in the graph is determined as the maximum peak temperature of heat of fusion (Ta). The Tu described below is measured in the same manner as described above.

The Ta of the crystalline resin (A) is 40 to 70° C., preferably 45 to 68° C., and more preferably 50 to 65° C. When the Ta of (A) is lower than 40° C., the heat resistant storage stability of the resin particle (X) is undesirably impaired. When the Ta is higher than 70° C., a minimum fixing temperature of (X) undesirably rises.

Examples of the crystalline resin (A) for use in the present invention include a crystalline polyester resin (A1), a crystalline polyurethane resin (A2), and a crystalline vinyl resin (A3).

As (A), (A1) to (A3) may be used individually or in combination.

Examples of the crystalline polyester resin (A1) include a crystalline polyester resin containing a diol (1), and a dicarboxylic acid (2) as constituent units thereof.

Examples of the diol (1) include alkylene glycols having 2 to 30 carbon atoms (e.g., ethylene glycol, 1,2-propylene glycol, 1,3-propylene glycol, 1,4-butanediol, 1,6-hexanediol, octanediol, decanediol, dodecanediol, tetradecanediol, neopentyl glycol, and 2,2-diethyl-1,3-propanediol); alkylene ether glycols having a number average molecular weight (hereinafter abbreviated as Mn) of 106 to 10,000 (e.g., diethylene glycol, triethylene glycol, dipropylene glycol, polyethylene glycol, polypropylene glycol, and polytetramethylene ether glycol); alicyclic diols having 6 to 24 carbon atoms (for example, 1,4-cyclohexanedimethanol and hydrogenated bisphenol A); alkylene oxide (hereinafter abbreviated as A0) adducts having an Mn of 100 to 10,000 (added mole number of 2 to 100) of the alicyclic diols [for example, ethylene oxide (hereinafter abbreviated as EO) 10 mol adduct of 1,4-cyclohexane dimethanol]; AO [e.g., EO, propylene oxide (hereinafter abbreviated as PO), and butylene oxide (hereinafter abbreviated as BO)] adduct (the number of moles added: 2 to 100) of a bisphenol having 15 to 30 carbon atoms (e.g., bisphenol A, bisphenol F, and bisphenol S) or a polyphenol having 12 to 24 carbon atoms (e.g., catechol, hydroquinone, and resorcin) (e.g., bisphenol A*EO (2 to 4 mol) adduct, and bisphenol A·PO (2 to 4 mol) adduct); polylactonediols having a weight average molecular weight (hereinafter abbreviated as Mw) of 100 to 5,000 (for example, poly-ε-caprolactonediol); and polybutadienediols having an Mw of 1,000 to 20,000.

Preferred of these are AO adducts of alkylene glycols and bisphenols, and AO adducts of bisphenols and mixtures of AO adducts of bisphenols and alkylene glycols are more preferred.

Examples of the dicarboxylic acid (2) include alkane dicarboxylic acids having 4 to 32 carbon atoms (e.g., succinic acid, adipic acid, sebacic acid, azelaic acid, dodecanedicarboxylic acid, and octadecanedicarboxylic acid); alkene dicarboxylic acids having 4 to 32 carbon atoms (e.g., maleic acid, fumaric acid, citraconic acid, and mesaconic acid); branched alkene dicarboxylic acids having 8 to 40 carbon atoms [for example, dimer acid, alkenylsuccinic acids (dodecenylsuccinic acid, pentadecenylsuccinic acid, octadecenylsuccinic acid, etc.); branched alkane dicarboxylic acids having 12 to 40 carbon atoms [for example, alkylsuccinic acids (decylsuccinic acid, dodecylsuccinic acid, octadecylsuccinic acid, etc.); aromatic dicarboxylic acids having 8 to 20 carbon atoms (for example, phthalic acid, isophthalic acid, terephthalic acid, naphthalene dicarboxylic acid, etc.).

Preferred of these are alkene dicarboxylic acids and aromatic dicarboxylic acids, and aromatic dicarboxylic acids are more preferred.

In view of the heat resistant storage stability of resin particle (X), (A1) is preferably such a combination that the total number of the carbon atoms of the diol (1) and the dicarboxylic acid (2) is 10 or more, more preferably 12 or more, and particularly preferably 14 or more. In view of low-temperature fixability when (X) is used as base particles of an electrophotographic toner, said total number of the carbon atoms is preferably 52 or less, more preferably 45 or less, particularly preferably 40 or less, and most preferably 30 or less.

Examples of the crystalline polyurethane resin (A2) include a crystalline polyurethane resin (A2-1) having the diol (1) and/or diamine (3), and diisocyanate (4) as constituent units thereof, and a crystalline polyurethane resin (A2-2) having the crystalline polyester resin (A1), the diol (1) and/or the diamine (3), and diisocyanate (4) as constituent units thereof.

Examples of the diamine (3) include aliphatic diamines having 2 to 18 carbon atoms and aromatic diamines having 6 to 20 carbon atoms.

Examples of the aliphatic diamines having 2 to 18 carbon atoms include linear aliphatic diamines and cyclic aliphatic diamines.

Examples of the linear aliphatic diamines include alkylenediamines having 2 to 12 carbon atoms (e.g., ethylenediamine, trimethylenediarnine, tetramethylenediamine, and hexamethylenediamine).

Examples of the cyclic aliphatic diamines include alicyclic diamines having 4 to 15 carbon atoms {e.g., 1,3-diaminocyclohexane, isophoronediamine, menthenediamine, 4,4′-methylenedicyclohexanediamine (hydrogenated methylenedianiline), and 3,9-bis(3-aminopropyl)-2,4,8,10-tetraoxaspiro[5,5]undecane}

Examples of the aromatic diamines having 6 to 20 carbon atoms include 1,2-, 1,3- or 1,4-phenylenediamine, 2,4′- or 4,4′-diphenylmethanediamine, diaminodiphenyl sulfone, benzidine, thiodianiline, bis (3,4-diaminophenyl)sulfone, 2,6-diaminopyridine, m-aminobenzylamine, naphthylenediamine, 2,4- or 2,6-tolylenediamine, crude tolylenediamine, diethyltolylenediamine, 4,4′-diamino-3,3′-dimethyldipheniylmethane, 4,4′-bis(o-toluidine), dianisidinie, diaminoditolylsulfone, 1,3-dimethyl-2,4-diaminobenzene, 1,3-diethyl-2,4-diaminobenzene, 1,3-dimethyl-2,6-diaminobenzene, 1,4-diethyl-2,5-diaminobenzene, 1,4-diisopropyl-2,5-diaminobenzene, 1,4-dibutyl-2,5-diaminobenzene, 2,4-diaminomesitylene, 1,3,5-triethyl-2,4-diaminobenzene, 1,3,5-triisopropyl-2,4-diaminobenzene, 1-methyl-3,5-diethyl-2,4-diaminobenzene, 1-methyl-3,5-diethyl-2,6-diaminobenzene, 2,3-dimethyl-1,4-diaminonaphthalene, 2,6-dimethyl-1,5-diaminonaphthalene, 2,6-diisopropyl-1,5-diaminonaphthalene, 2,6-dibutyl-1,5-diaminonaphthalene, 3,3′5,5′-tetramethylbenzidine, 3,3′,5,5′-tetraisopropylbenzidine, 3,3′,5,5′-tetramethyl-4,4′-diaminodiphenylmethane, 3,3′,5,5′-tetraethyl-4,4′-diaminodiphenylmethane, 3,3′,5,5′-tetraisopropyl-4,4′-diaminodiphenylmethane, 3,3′,5,5′-tetrabutyl-4,4′-diaminodiphenylmethane, 3,5-diethyl-3′-methyl-2′,4-diaminodiphenylmethane, 3,5-diisopropyl-3′-methyl-2′,4-diaminodiphenylmethane, 3,3′-diethyl-2,2′-diaminodiphenylmethane, 4,4′-diamino-3,3′-dimethyldiphenylmethane, 3,3′,5,5′-tetraethyl-4,4′-diaminobenzophenone, 3,3′,5,5′-tetraisopropyl-4,4′-diaminobenzophenone, 3,3′,5,5′-tetraethyl-4,4′-diaminodiphenyl ether, 3,3′,5,5′-tetraisopropyl-4,4′-diaminodiphenylsulfone, and mixtures thereof.

Examples of the diisocyanate (4) include aromatic diisocyanates having 6 to 20 carbon atoms (excluding the carbon atoms in NCO groups, which applies hereinafter), aliphatic diisocyanates having 2 to 18 carbon atoms, modified products (e.g., modified products containing a urethane group, a carbodiimide group, an allophanate group, a urea group, a biuret group, a uretdione group, a uretimine group, an isocyanurate group, or an oxazolidone group) of the preceding diisocyanates, and mixtures of two or more of the preceding diisocyanates.

Examples of the aromatic diisocyanates include 1,3- or 1,4-phenylene diisocyanate, 2,4- or 2,6-tolylene diisocyanate (TDI), crude TDI, m- or p-xylylene diisocyanate (XDI), α,α,α′,α′-tetramethylxylylene diisocyanate (TMXDI), 2,4′- or 4,4′-diphenylmethane diisocyanate (MDI), crude MDI (crude diaminophenylmethane [a condensate made up of formaldehyde and an aromatic amine (aniline) or a mixture of aromatic amines, and mixtures thereof.

Examples of the aliphatic diisocyanates include linear aliphatic diisocyanates and cyclic aliphatic diisocyanates.

Examples of the linear aliphatic diisocyanates include ethylene diisocyanate, tetramethylene diisocyanate, hexamethylene diisocyanate (HDI), dodecamethylene diisocyanate, 2,2,4-trimethyihexamethylene diisocyanate, lysine diisocyanate, 2,6-diisocyanatomethylcaproate, bis(2-isocyanatoethyl)fumarate, bis(2-isocyanatoethyl)carbonate, and mixtures thereof.

Examples of the cyclic aliphatic diisocyanates include isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, 2,5- or 2,6-norbornane diisocyanate, and mixtures thereof.

Examples of modified products of diisocyanates to be used include modified products containing a urethane group, a carbodiimide group, an allophanate group, a urea group, a biuret group, a urethodione group, a urethoimine group, an isocyanurate group and/or an oxazolidone group, and specific examples thereof include modified MDI (e.g., urethane-modified MDI, carbodiimide-modified MDI, and trihydrocarbyl phosphate-modified MDI), urethane-modified TDI, and mixtures thereof [e.g., a mixture of a modified MDI and a urethane-modified TDI (an isocyanate-containing prepolymer)].

Preferred of the diisocyanates (4) are aromatic diisocyanates having 6 to 15 carbon atoms and aliphatic diisocyanates having 4 to 15 carbon atoms, and TDI, MDI, HDI, hydrogenated MDI, and IPDI are more preferred.

The crystalline polyurethane resin (A2) may contain, in addition to the diol (1), a diol (1′) containing at least one selected from the group consisting of a carboxylic acid (salt) group, a sulfonic acid (salt) group, a sulfamic acid (salt) group, and a phosphoric acid (salt) group, as constituent units thereof. The (A2) containing the diol (1′) as a constituent unit thereof can contribute to improvement in electrostatic property and heat resistant storage stability of the resin particle (X).

In the present specification, “acid (salt)” means acid or acid salt.

Examples of the diol (1′) having a carboxylic acid (salt) group include tartaric acid (salt), 2,2-bis(hydroxymethyl)propanoic acid (salt), 2,2-bis(hydroxymethyl)butanoic acid (salt) and 3-[bis(2-hydroxyethyl)amino]propanoic acid (salt).

Examples of the diol (1′) having a sulfonic acid (salt) group include 2,2-bis(hydroxymethyl)ethane sulfonic acid (salt), 2-[bis(2-hydroxyethyl)amino]ethane sulfonic acid (salt), and 5-sulfo-isophthalic acid-1,3-bis(2-hydroxyethyl)ester (salt).

Examples of the diol (1′) having a sulfamic acid (salt) group include N,N-bis(2-hydroxyethyl)sulfamic acid (salt), N,N-bis(3-hydroxypropyl)sulfamic acid (salt), N,N-bis(4-hydroxybutyl)sulfamic acid (salt), and N,N-bis(2-hydroxypropyl)sulfamic acid (salt).

Examples of the diol (1′) having a phosphoric acid (salt) group include bis(2-hydroxyethyl)phosphate (salt).

Examples of the salt that constitutes an acid salt include ammonium salt, amine salts (methylamine salt, dimethylamine salt, trimethylamine salt, ethylamine salt, diethylamine salt, triethylamine salt, propylamine salt, dipropylamine salt, tripropylamine salt, butylamine salt, dibutylamine salt, tributylamine salt, monoethanolamine salt, diethanolamine salt, triethanolamine salt, N-methylethanolamine salt, N-ethylethanolamine salt, N,N-dimethylethanolamine salt, N,N-diethylethanolamine salt, hydroxylamine salt, N,N-diethylhydroxylamine salt, morpholine salt, etc.), quaternary ammonium salts [tetramethylammonium salt, tetraethylammonium salt, trimethyl(2-hydroxyethyl)ammonium salt, etc.], and alkali metal salts (sodium salt, potassium salt, etc.).

Among the diols (1′), preferred are the diol (1′) having a carboxylic acid (salt) group and the diol (1′) having a sulfonic acid (salt) group in view of the electrostatic property and the heat resistant storage stability of the resin particle (X).

The crystalline vinyl resin (A3) is a polymer resulting from homopolymerization or copolymerization of a monomer having a polymerizable double bond. Examples of the monomer having a polymerizable double bond include the following (5) to (14).

(5) Hydrocarbon having a polymerizable double bond:

(5-1) Aliphatic hydrocarbon having a polymerizable double bond:

(5-1-1) Linear hydrocarbon having a polymerizable double bond: alkenes having 2 to 30 carbon atoms (e.g., ethylene, propylene, butene, isobutylene, pentene, heptene, diisobutylene, octene, dodecene, and octadecene); alkadienes having 4 to 30 carbon atoms (e.g., butadiene, isoprene, 1,4-pentadiene, 1,6-hexadiene, and 1,7-octadiene).

(5-1-2) Cyclic hydrocarbon having a polymerizable double bond: mono- or dicycloalkenes having 6 to 30 carbon atoms (e.g., cyclohexene, vinylcyclohexene, and ethylidene bicycloheptene), and mono- or dicycloalkadienes having 5 to 30 carbon atoms (e.g., (di)cyclopentadiene].

(5-2) Aromatic hydrocarbons having a polymerizable double bond: styrene; hydrocarbyl (alkyl having 1 to 30 carbon atoms, cycloalkyl, aralkyl and/or alkenyl)-substituted styrene (e.g., α-methylstyrene, vinyltoluene, 2,4-dimethylstyrene, ethylstyrene, isopropylstyrene, butylstyrene, phenylstyrene, cyclohexylstyrene, benzylstyrene, crotylbenzene, divinylbenzene, divinyltoluene, divinylxylene, and trivinylbenzene); and vinylnaphthalene.

(6) Monomers having a carboxyl group and a polymerizable double bond, and their salts:

Unsaturated monocarboxylic acids having 3 to 15 carbon atoms (e.g., (meth)acrylic acids [“(meth)acryl” means acryl or methacryll, crotonic acid, isocrotonic acid, and cinnamic acid); unsaturated dicarboxylic acids having 3 to 30 carbon atoms or anhydrides thereof (e.g., maleic acid (anhydride), fumaric acid, itaconic acid, citraconic acid (anhydride), and mesaconic acid]; and monoalkyl (having 1 to 10 carbon atoms) esters of unsaturated dicarboxylic acids having 3 to 10 carbon atoms (e.g., monomethyl maleate, monodecyl maleate, monoethyl fumarate, monobutyl itaconate, and monodecyl citraconate), etc.

Examples of the salts that constitute the salts of monomers having a carboxyl group and a polymerizable double bond include alkali metal salts (sodium salts, potassium salts, etc.), alkaline earth metal salts (calcium salts, magnesium salts, etc.), ammonium salts, amine salts, and quaternary ammonium salts.

The amine salts are not particularly restricted as long as they are amine compounds and examples thereof include primary amine salts (ethylamine salts, butylamine salts, octylamine salts, etc.), secondary amines (diethylamine salts, dibutylamine salts, etc.), tertiary amines (triethylamine salts, tributylamine salts, etc.). Examples of the quaternary ammonium salts include tetraethylammonium salts, triethyllaurylammonium salts, tetrabutylammonium salts, and tributyllaurylammonium salts.

Examples of the salts of monomers having a carboxyl group and a polymerizable double bond include sodium acrylate, sodium methacrylate, monosodium maleate, disodium maleate, potassium acrylate, potassium methacrylate, monopotassium maleate, lithium acrylate, cesium acrylate, ammonium acrylate, calcium acrylate, and aluminum acrylate.

(7) Monomers having a sulfo group and a polymerizable double bond, and their salts:

Alkene sulfonic acids having 2 to 14 carbon atoms (e.g., vinylsulfonic acid, (meth)allylsulfonic acid, and methylvinylsulfonic acid); styrene sulfonic acids and alkyl (having 2 to 24 carbon atoms)-derivatives thereof (e.g., α-methylstyrene sulfonic acid; sulfo(hydroxy)alkyl(meth)acrylates having 5 to 18 carbon atoms (e.g., sulfopropyl (meth)acrylate, 2-hydroxy-3-(meth)acryloxypropane sulfonic acid, 2-(meth)acryloyloxyethane sulfonic acid, and 3-(meth)acryloyloxy-2-hydroxypropane sulfonic acid); sulfo(hydroxy)alkyl (having 5 to 18 carbon atoms) (meth)acrylamides [e.g., 2-(meth)acryloylamino-2,2-dimethylethanesulfonic acid, 2-(meth)acrylamide-2-methylpropanesulfonic acid, and 3-(meth)acrylamide-2-hydroxypropanesulfonic acid]; alkyl(having 3 to 18 carbon atoms)allylsulfosuccinic acids (e.g., propylallylsulfosuccinic acid, butylallylsulfosuccinic acid, and 2-ethylhexyl-allylsulfosuccinic acid); sulfuric acid esters of poly [n (polymerization degree, the same applies hereinafter)=2 to 30] oxyalkylene (e.g., oxyethylene, oxypropylene, and oxybutylene; oxyalkylene may be used alone or in combination; when used in combination, the added mode may be either random addition or block addition) mono(meth)acrylates (e.g., sulfuric acid esters of poly(n=5 to 15)oxyethylene monomethacrylates, and sulfuric acid esters of poly(n=5 to 15)oxypropylene monomethacrylates); compounds represented by the following general formulae (1) to (3); and salts thereof. Examples of the salts include those provided as the salts that form (6) the salts of the monomers having a carboxyl group and a polymerizable double bond.

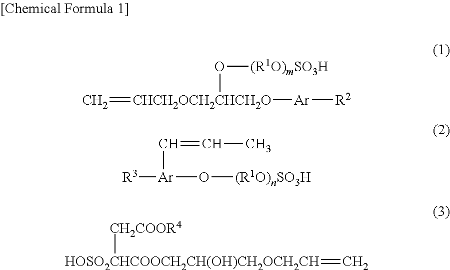

In the formulae, R¹ is an alkylene group having 2 to 4 carbon atoms; R¹O may be used alone or in combination, and in the case where it is used in combination, the bonding mode may be either random or block; R² and R³ each independently represent an alkyl group having 1 to 15 carbon atoms; m and n each independently represent the integer of 1 to 50; Ar represents a benzene ring; R⁴ represents an alkyl group having 1 to 15 carbon atoms optionally substituted with a fluorine atom.

(8) Monomers having a phosphono group and a polymerizable double bond, and their salts:

(Meth)acryloyloxyalkyl monophosphates (the alkyl group has 1 to 24 carbon atoms) (e.g., 2-hydroxyethyl(meth)acryloyl phosphate and phenyl-2-acryloyloxyethyl phosphate), and (meth)acryloyloxyalkyl phosphonates (the alkyl group has 1 to 24 carbon atoms) (e.g., 2-acryloyloxyethyl phosphonic acid).

Examples of the salts include those provided as the salts that form (6) the monomers having a carboxyl group and a polymerizable double bond.

(9) Monomers having a hydroxyl group and a polymerizable double bond:

Hydroxystyrene, N-methylol(meth)acrylamide, hydroxyethyl (meth)acrylate, hydroxypropyl (meth)acrylate, polyethylene glycol mono(meth)acrylate, (meth)allyl alcohol, crotyl alcohol, isocrotyl alcohol, 1-buten-3-ol, 2-buten-1-ol, 2-butene-1,4-diol, propargyl alcohol, 2-hydroxyethyl propenyl ether, sucrose allyl ether, etc.

(10) Nitrogen-containing monomers having a polymerizable double bond:

(10-1) Monomers having an amino group and a polymerizable double bond:

Aminoethyl (meth)acrylate, dimethylaminoethyl (meth)acrylate, diethylaminoethyl (meth)acrylate, tert-butylaminoethyl methacrylate, N-aminoethyl (meth)acrylamide, (meth)allylamine, morpholinoethyl (meth)acrylate, 4-vinylpyridine, 2-vinylpyridine, crotylamine, N,N-dimethylaminostyrene, methyl-α-acetaminoacrylate, vinylimidazole, N-vinylpyrrole, N-vinylthiopyrrolidone, N-arylphenylenediamine, aminocarbazole, aminothiazole, aminoindole, aminopyrrole, aminoimidazole, aminomercaptothiazole, salts thereof, and so on.

(10-2) Monomers having an amide group and a polymerizable double bond:

(Meth)acrylamide, N-methyl(meth)acrylamide, N-butylacrylamide, diacetone acrylamide, N-methylol(meth)acrylamide, N,N′-methylene-bis(meth)acrylamide, cinnamide, N,N-dimethylacrylamide, N,N-dibenzylacrylamide, methacrylformamide, N-methyl-N-vinylacetamide, N-vinylpyrrolidone, etc.

(10-3) Monomers having 3 to 10 carbon atoms and having a nitrile group and a polymerizable double bond:

(Meth)acrylonitrile, cyanostyrene, cyanoacrylate, etc.

(10-4) Monomers having 8 to 12 carbon atoms and having a nitro group and a polymerizable double bond:

Nitrostyrene, etc.

(11) Monomers having 6 to 18 carbon atoms and having an epoxy group and a polymerizable double bond:

Glycidyl (meth)acrylate, p-vinylphenylphenyl oxide, etc.

(12) Monomers having 2 to 16 carbon atoms and having a halogen element and a polymerizable double bond:

Vinyl chloride, vinyl bromide, vinylidene chloride, allyl chloride, chlorostyrene, bromostyrene, dichlorostyrene, chloromethylstyrene, tetrafluorostyrene, chloroprene, etc.

(13) Esters having a polymerizable double bond, ethers having a polymerizable double bond, ketones having a polymerizable double bond, and sulfur-containing compounds having a polymerizable double bond:

(13-1) Esters having 4 to 16 carbon atoms and having a polymerizable double bond:

Vinyl acetate, vinyl propionate, vinyl butyrate, diallyl phthalate, diallyl adipate, isopropenyl acetate, vinyl methacrylate, methyl-4-vinyl benzoate, cyclohexyl methacrylate, benzyl methacrylate, phenyl (meth)acrylate, vinyl methoxyacetate, vinyl benzoate, ethyl-α-ethoxyacrylate, alkyl (meth)acrylates having an alkyl group having 1 to 50 carbon atoms [methyl (meth)acrylate, ethyl (meth)acrylate, propyl (meth)acrylate, butyl (meth)acrylate, 2-ethylhexyl (meth)acrylate, dodecyl (meth)acrylate, hexadecyl (meth)acrylate, heptadecyl (meth)acrylate, eicosyl (meth)acrylate, etc.], dialkyl fumarates (the two alkyl groups are linear, branched, or alicyclic groups having 2 to 8 carbon atoms), dialkyl maleates (the two alkyl groups are linear, branched, or alicyclic groups having 2 to 8 carbon atoms), poly(meth)allyloxyalkanes (diallyloxyethane, triallyloxyethane, tetraallyloxyethane, tetraallyloxypropane, tetraallyloxybutane, tetramethallyloxyethane, etc.), monomers having a polyalkylene glycol chain and a polymerizable double bond [polyethylene glycol (Mn=300) mono(meth)acrylate, polypropylene glycol (Mn=500) monoacrylate, methanol 10 mol EO adduct (meth)acrylate, lauryl alcohol 30 mol EO adduct (meth)acrylate, etc.], poly(meth)acrylates [poly(meth)acrylates of polyhydric alcohols: ethylene glycol di(meth)acrylate, propylene glycol di(meth)acrylate, neopentyl glycol di(meth)acrylate, trimethylolpropane tri(meth)acrylate, polyethylene glycol di(meth)acrylate, etc.] are provided as examples.

(13-2) Ethers having 3 to 16 carbon atoms and having a polymerizable double bond:

Vinyl methyl ether, vinyl ethyl ether, vinyl propyl ether, vinyl butyl ether, vinyl-2-ethyl hexyl ether, vinyl phenyl ether, vinyl-2-methoxyethyl ether, methoxybutadiene, vinyl-2-butoxyethyl ether, 3,4-dihydro-1,2-pyrane, 2-butoxy-2′-vinyloxydiethyl ether, acetoxystyrene, and phenoxystyrene are provided as examples.

(13-3) Ketones having 4 to 12 carbon atoms and having a polymerizable double bond:

Vinyl methyl ketone, vinyl ethyl ketone, and vinyl phenyl ketone are provided as examples.

(13-4) Sulfur-containing compounds having 2 to 16 carbon atoms and having a polymerizable double bond:

Divinyl sulfide, p-vinyldiphenyl sulfide, vinylethyl sulfide, vinyl ethyl sulfone, divinyl sulfone, and divinyl sulfoxide are provided as examples.

In view of adhesion strength of the resin particle (X), among the crystalline resins (A), the crystalline polyester resin (A1) and the crystalline polyurethane resin (A2) are preferable, (A2) is more preferable, (A2-2) is particularly preferable, and the most preferred among (A2-2) is one having an ester group and a urethane group in the molecule thereof.

The crystalline resin (A) for use in the present invention may be either a resin constituted exclusively of a crystalline segment (a) made of the aforementioned (A) or a block resin having one or more crystalline segments (a) and one or more non-crystalline segments (a′) made of a non-crystalline resin (A′).

Examples of the non-crystalline resin (A′) for use in the present invention include resins having the same composition as the crystalline polyester resin (A1), the crystalline polyurethane resin (A2), and the crystalline vinyl resin (A3) listed as examples of the crystalline resin (A) and having a ratio of Tm to Ta (Tm/Ta) of larger than 1.55.

When the crystalline resin (A) is a block resin composed of the crystalline segment (a) and the non-crystalline segment (a′), whether or not a bonding agent is used is selected considering the reactivity of terminal functional groups of both (a) and (a′). When the bonding agent is used, it is possible to select a bonding agent that is suited to the terminal functional groups and bond (a) and (a′) to form a block resin.

When no bonding agent is used, a terminal functional group of (A) to form (a) and a terminal functional group of (A′) to form (a′) are allowed to react optionally with heating and decompressing. In particular, in the case of a reaction between an acid and an alcohol or a reaction between an acid and an amine, the reaction proceeds smoothly when one of the resins has a high acid value and the other resin has a high hydroxyl value or a high amine value. Preferably, the reaction is performed at a temperature of 180° C. to 230° C.

When a bonding agent is used, a variety of bonding agents can be used. Examples of the bonding agent include the diol (1), the dicarboxylic acid (2), the diamine (3), the diisocyanate (4), and polyfunctional epoxy.

Examples of the polyfunctional epoxy include a bisphenol A or F epoxy compound, a phenol novolak epoxy compound, a cresol novolak epoxy compound, a hydrogenated bisphenol A epoxy compound, diglycidyl ether of AO adduct of bisphenol A or F, diglycidyl ether of AO adduct of hydrogenated bisphenol A, diglycidyl ethers of diols (e.g., ethylene glycol, propylene glycol, neopentyl glycol, butanediol, hexanediol, cyclohexane dimethanol, polyethylene glycol, and polypropylene glycol), trimethylol propane and/or triglycidyl ether, pentaerythritol and/or tetraglycidyl ether, sorbitol hepta- and/or hexaglycidyl ether, resorcin diglycidyl ether, dicyclopentadiene-phenol added glycidyl ether, methylene bis(2,7-dihydroxynaphthalene)tetraglycidyl ether, 1,6-dihydroxynaphthalene diglycidyl ether, and polybutadiene diglycidyl ether.

Examples of the method for bonding (a) and (a′) together include a dehydration reaction between (a) and (a′), and an addition reaction between (a) and (a′).

Examples of the dehydration reaction include a reaction that, where both (a) and (a′) have hydroxyl groups, these hydroxyl groups are bonded together with a bonding agent [e.g., a dicarboxylic acid (2)]. The dehydration reaction can be performed at a reaction temperature of 180 to 230° C. in the absence of any solvent.

Examples of the addition reaction include a reaction that, where both (a) and (a′) have hydroxyl groups, these hydroxyl groups are bonded together with a bonding agent [e.g., a diisocyanate (4)], and a reaction that, where either (a) or (a′) is a resin having a hydroxyl group and the other is a resin having an isocyanate group, the hydroxyl group and the isocyanate group are bonded together without a bonding agent. The addition reaction can be carried out by dissolving both (a) and (a′) in a solvent that can dissolve both (a) and (a′), optionally adding a bonding agent, and allowing them to react at a reaction temperature of 80° C. to 150° C.

When the crystalline resin (A) is a block resin composed of (a) and (a′), the (a) content in (A) is preferably 50 to 99% by weight, more preferably 55 to 98% by weight, particularly preferably 60 to 95% by weight, and most preferably 62 to 80% by weight. The (a) content falling within the aforementioned range is preferable because if so, the crystallinity of (A) is not impaired and excellent low-temperature fixability, storage stability, and glossiness of (X) are attained.

In view of low-temperature fixability, the content of the crystalline part (a) based on the weight of (X) in the resin particle (X) is preferably 30 to 95% by weight, more preferably 40 to 94% by weight, and particularly preferably 45 to 94% by weight.

The total endotherm of the crystalline resin (A) is preferably 20 to 150 J/g, more preferably 30 to 120 J/g, and particularly preferably 40 to 100 J/g. Preferably, the total endotherm is 20 J/g or more because, if so, the water resistance of the resin particle (X) is improved, and the total endotherm is 150 J/g or less because, if so, the low-temperature fixability of (X) becomes excellent.

The total endotherm of (A) can be measured by the following method.

### <Method for Measuring Total Endotherm of (A)>

The measurement is performed by means of a differential scanning calorimeter, e.g., DSC Q1000 (manufactured by TA Instruments) under the following conditions.

Temperature rising speed: 10° C./min

Measurement onset temperature: 20° C.

Measurement offset temperature: 180° C.

As to the temperature calibration of a detecting element of the device, the melting points of indium and zinc are used. As to the calibration of heat, the heat of fusion of indium is used.

Specifically, about 5 mg of sample is weighed precisely and put into a silver pan, and then endotherm measurement is performed once to obtain a DSC curve. From this DSC curve, the total endotherm of (A) is determined. An empty silver pan is used as a reference.

The Mn of the crystalline resin (A) is preferably 1,000 to 5,000,000, more preferably 2,000 to 500,000.

The Mn and the Mw of the resin and the resin particle (X) for use in the present invention can be measured by gel permeation chromatography (GPC) under the following conditions.

Instrument (one example): “HLC-8120” [manufactured by Tosoh Corporation]

Column (one example): “TSK GEL GMH6” [manufactured by Tosoh Corporation], two columns

Measurement temperature: 40° C.

Sample solution: 0.25% by weight solution in tetrahydrofuran (filtrate obtained by filtering off insolubles with a glass filter)

Solution injection amount: 100 μl

Detector: refractive index detector

Standard substance: standard polystyrene (TSK standard POLYSTYRENE) 12 items (molecular weight: 500, 1,050, 2,800, 5,970, 9,100, 18,100, 37,900, 96,400, 190,000, 355,000, 1,090,000, 2,890,000) [produced by Tosoh Corporation]

The solubility parameter (hereinafter referred to as “SP value”) of the crystalline resin (A) is preferably 7 to 18 (cal/cm³)^{1/2}, more preferably 8 to 16 (cal/cm³)^{1/2}, and particularly preferably 9 to 14 (cal/cm³)^{1/2}.

The SP value in the present invention can be calculated by the method described by Fedors [Polym. Eng. Sci. 14(2), 152 (1974)].

The glass transition temperature (hereinafter abbreviated as “Tg”) of the crystalline resin (A) is preferably 20° C. to 200° C., more preferably 40° C. to 150° C. When the Tg is 20° C. or higher, the storage stability of the particle particles (B) is good. The Tg can be measured by means of, for example, “DSC20, SSC/580” [manufactured by Seiko Instruments Inc.] in accordance with the method (DSC) specified in ASTM D3418-82.

Examples of the crystalline polyurethane resin (B) for use in the present invention include ones having the same compositions as those provided as examples of the crystalline polyurethane resin (A2).

The Tu of the crystalline polyurethane resin (B) is 50 to 90° C., preferably 53 to 83° C., and more preferably 55 to 85° C. When the Tu of (B) is lower than 50° C., this is undesirable because the heat resistant storage stability of the resin particle (X) is impaired, whereas when the Tu is higher than 90° C., this is undesirable because the minimum fixing temperature of the (X) becomes higher.

The crystalline polyurethane resin (B) preferably satisfies the following condition 2. The crystalline polyurethane resin (B) satisfying the condition 2 can contribute to an improvement in the adhesion strength of the resin particle (X).

0.94×(B:urethane)+0.70×(B:urea)+0.00032×(B:Mw)−9.2≧5 [Condition 2]

(B:urethane) in condition 2 is the urethane group concentration (% by weight) of (B).

(B:urea) in condition 2 is the urea group concentration (% by weight) of (B).

(B:Mw) in condition 2 is the Mw of (B).

In the present invention, (B:urethane) and (B:urea) in (B) are calculated from an N atom content determined with a nitrogen analyzer (e.g. ANTEK7000, manufactured by Antec, Inc.) and a ratio of urethane groups to urea groups determined by NMR.

When an amine compound has been used as a catalyst and/or an additive in the production of (B), the value associated with such an amine compound needs to be subtracted from the measurement value. When the used amine compound has a boiling point of lower than 70° C., there can be used a method in which a sample is dried for 2 hours at 130° C. under reduced pressure and then subjected to the measurement. When the used amine compound has a boiling point of 70° C. or higher, there can be used a method in which a sample is subjected as received to the measurement and the value obtained by subtracting the N atom content calculated from the loaded amount of the amine compound from the N atom content as measured is determined as the N atom content.

The NMR measurement can be performed in accordance with the method disclosed in “Structural Study of Polyurethane Resin by NMR: Journal of the Takeda Research Laboratories 34(2), 224-323 (1975)”. Specifically, ¹H-NMR analysis is performed to determine a weight ratio of urea groups to urethane groups from the ratio of an integrated value of hydrogen originated from a urea group near the chemical shift of 6 ppm and an integrated value of hydrogen originated from a urethane group near the chemical shift of 7 ppm, and the amount of urea groups and the amount of urethane groups are calculated from the weight ratio and the aforementioned N atom content.

The urea group content and the urethane group content can be controlled by appropriately controlling the composition of raw materials and the equivalent amounts thereof to be loaded.

In view of the adhesion strength of the resin particle (X), the lower limit of the left side of the formula of condition 2 is preferably 5.5, and more preferably 6.0.

(B:urethane) in condition 2 is preferably 1.0 to 30% by weight, more preferably 2.0 to 20% by weight.

(B:urea) in condition 2 is preferably 0.05 to 5% by weight, more preferably 0.1 to 2% by weight.

(B:Mw) in condition 2 is preferably 5,000 to 100,000, more preferably 10,000 to 70,000.

The acid value of the crystalline polyurethane resin (B) is preferably 5 to 200 (mgKOH/g), more preferably 10 to 150 (mgKOH/g), and most preferably 15 to 100 (mgKOH/g). When the acid value of (B) is 5 (mgKOH/g) or higher, resin particles (E) containing (B) are easily dispersed in a continuous phase medium (O) in the method for producing the resin particle (X) described below. When the acid value of (B) is 200 (mgKOH/g) or lower, the water resistance of (X) is good.

The acid value of (B) can be measured by the method specified in JIS K0070.

The SP value of the crystalline polyurethane resin (B) is preferably 9.0 to 14 (cal/cm³)^{1/2}, more preferably 9.5 to 13 (cal/cm³)^{1/2}, and particularly preferably 9.8 to 12 (cal/cm)^{1/2}.

The resin particle (X) of the present invention has a shell layer (S) containing the crystalline polyurethane resin (B) on a surface of a core layer (Q) containing the crystalline resin (A).

The weight ratio [(Q):(S)] of the core layer (Q) to the shell layer (S) is preferably from 99.9:0.1 to 75:25, more preferably from 99.5:0.5 to 80:20, and particularly preferably from 99:1 to 90:10.

The resin particle (X) of the present invention preferably satisfies the following condition 1.

0≦(Tu)−(Ta)≦30 [Condition 1]

In condition 1, the closer to the upper limit the value of (Tu)−(Ta), the better the heat resistant storage stability of the resin particle (X) is. The closer to the lower limit the value of (Tu)−(Ta), the better the low-temperature fixability of the resin particle (X) is.

The lower limit of (Tu)−(Ta) of condition 1 is preferably 5, more preferably 10.

The upper limit of (Tu)−(Ta) of condition 1 is preferably 25, more preferably 20.

In view of the low-temperature fixability and the heat resistant storage stability of the resin particle (X), the molecular weight distribution of the resin particle (X) (Mw/Mn is defined as the molecular weight distribution in the present invention) is preferably 3.5 to 100, more preferably 4.0 to 80, and particularly preferably 4.5 to 50.

The volume average particle diameter of the resin particle (X) is preferably 0.0005 to 30 μm, more preferably 0.01 to 20 μm, and particularly preferably 0.02 to 10 μm.

The volume average particle diameter of (X) can be measured by means of a laser particle size distribution analyzer, such as “LA-920” [manufactured by HORIBA, Ltd.] and “Multisizer III” [manufactured by Beckman Coulter, Inc.], “ELS-800” [manufactured by Otsuka Electronics Co., Ltd.], which uses a laser Doppler method as an optical system, “LB-550” [manufactured by Shimadzu Corporation], which uses a light scattering method, or the like.

In view of flowability, melt-leveling property, and so on, the average circularity of the resin particle (X) is preferably 0.96 to 1.0, more preferably 0.97 to 1.0, and particularly preferably 0.98 to 1.0. The average circularity of (X) is the value obtained by optically detecting a particle, and dividing a circumferential length of an equivalent circle having the same projection area by a circumferential length of an actual particle; the value thereof closer to 1.0 means that the shape of the particle is closer to a true sphere. The average circularity of (X) can be measured by means of a flow particle image analyzer, e.g., “FPIA-2000” [manufactured by Sysmex Corporation].

The method for producing the resin particle (X) is not particularly restricted, but use of the method of the present invention for producing (X) can provide good particle size distribution.

The method of the present invention for producing the resin particle (X) is a method of producing a resin particle (X) resulting from attachment of a resin particle (E) to the surface of a resin particle (G) containing a crystalline resin (A), wherein the resin particle (X) is obtained by dispersing a solution (D) prepared by dissolving the crystalline resin (A) in an organic solvent (C) in a dispersion medium (F) containing the resin particle (E) containing a crystalline polyurethane resin (B), and then removing the organic solvent (C) and the continuous phase medium (F), and wherein the resin particle (X) is structured to have a shell layer (S) containing the crystalline polyurethane resin (B) on the surface of a core layer (Q) containing the crystalline resin (A), the maximum peak temperature (Ta) of the heat of fusion of the crystalline resin (A) is 40 to 70° C., and the maximum peak temperature (Tu) of the heat of fusion of the crystalline polyurethane resin (B) is 50 to 90° C.

The crystalline resin (A), the crystalline polyurethane resin (B), Ta of (A), and Tu of (B) in the method of the present invention for producing the resin particle (X) are the same as those mentioned supra, and the preferable ranges thereof are also the same as those described supra.

In the method of the present invention for producing the resin particle (X), as the crystalline resin (A), one obtained from the precursor (A0) thereof may be used.

The precursor (A0) is not particularly restricted as long as it can become a resin (A) as a result of a chemical reaction. In the case where (A) is the crystalline polyester resin (A1) or the crystalline polyurethane resin (A2), examples of (A0) include a combination of a prepolymer (a) having a reactive group and a curing agent (β).

In the case where (A) is the crystalline vinyl resin (A3), examples of (A0) include the aforementioned monomers (5) to (14).

In view of adhesion strength, preferred among (A0) is a combination of a prepolymer (α) having a reactive group and a curing agent (β).

In the case where a combination of a prepolymer (α) having a reactive group and a curing agent (β) is used as the precursor (A0), the “reactive group” possessed by (α) means a group reactive with the curing agent (α). In this case, examples of a method for reacting the precursor (A0) to form (A) include a method in which (α) and (β) are dispersed in a dispersion medium (W) described below and the (α) and (β) are made to react by heating to form (A).

Examples of the combination of the reactive group possessed by the reactive group-containing prepolymer (α) and the curing agent (β) include the following [1] and [2].

[1]A combination in which the reactive group which (α) has is a functional group (α1) capable of reacting with an active hydrogen compound and the (α) is an active hydrogen group-containing compound (β1).
[2]A combination in which the reactive group which the (α) has is an active hydrogen-containing group (α2) and the (β) is a compound (β2) capable of reacting with an active hydrogen-containing group.

In the combination [1], examples of the functional group (α1) capable of reacting with an active hydrogen compound include an isocyanate group (α1a), a blocked isocyanate group (α1b), an epoxy group (α1c), an acid anhydride group (α1d), and an acid halide group (α1e). Preferred of these are (α1a), (α1b), and (α1c), and the (α1a) and the (α1b) are more preferred.

The blocked isocyanate group (α1b) refers to an isocyanate group blocked with a blocking agent.

Examples of the blocking agent include oximes (e.g., acetoxime, methyl isobutyl ketoxime, diethyl ketoxime, cyclopentanone oxime, cyclohexanone oxime and methyl ethyl ketoxime), lactams (e.g., γ-butyrolactam, ε-caprolactam, and γ-valerolactam), aliphatic alcohols having 1 to 20 carbon atoms (e.g., ethanol, methanol, and octanol), phenols (e.g., phenol, m-cresol, xylenol, and nonylphenol), active methylene compounds (e.g., acetylacetone, ethyl malonate, and ethyl acetoacetate), basic nitrogen-containing compounds (e.g., N,N-diethylhydroxylamine, 2-hydroxypiridine, pyridine N-oxide, and 2-mercaptopyridine), and mixtures of two or more of them.

Of these, oximes are preferred, and methyl ethyl ketoxime is more preferred.

Examples of the constituent unit of the reactive group-containing prepolymer (α) include polyether (αw), polyester (αx), an epoxy resin (αy), and polyurethane (αz). Among them, preferred are (αx), (αy) and (αz), and more preferred are (αx) and (αz).

Examples of the polyether (αw) include polyethylene oxide, polypropylene oxide, and polybutylene oxide.

Examples of the polyester (αx) include a polycondensate of the diol (1) and the dicarboxylic acid (2), and polylactone (a ring-opening polymerization product of ε-caprolactone).

Examples of the epoxy resin (αy) include an addition condensate of a bisphenol (e.g., bisphenol A, bisphenol F, and bisphenol S) and epichlorohydrin.

Examples of the polyurethane (αz) include a polyaddition product of the diol (1) and the diisocyanate (4), and a polyaddition product of the polyester (εx) and the diisocyanate (4).

Examples of the method for introducing a reactive group into the polyester (αx), the epoxy resin (αy) or the polyurethane (αz) include:

[1] a method of allowing a functional group of a constituent component to remain in an end thereof by using one of two or more constituent components excessively, and
[2] a method of allowing a functional group of a constituent component to remain in an end thereof by using one of two or more constituent components excessively, and then allowing a functional group reactive with the remaining functional group, and a compound containing a reactive group to react.

In the above method [1], a hydroxyl group-containing polyester prepolymer, a carboxyl group-containing polyester prepolymer, an acid halide group-containing polyester prepolymer, a hydroxyl group-containing epoxy resin prepolymer, an epoxy group-containing epoxy resin prepolymer, a hydroxyl group-containing polyurethane prepolymer, an isocyanate group-containing polyurethane prepolymer, or the like can be obtained.

As to the proportions of the constituent components, in the case of, for example, a hydroxyl group-containing polyester prepolymer, the ratio of the polyol component to the polycarboxylic acid component, expressed by the equivalent ratio [OH]/[COOH] of hydroxyl groups [OH] to carboxyl groups [COOH], is preferably from 2/1 to 1/1, more preferably from 1.5/1 to 1/1, and particularly preferably from 1.3/1 to 1.02/1. Also in the case of a prepolymer having a different backbone or a different terminal group, only the constituent components vary but the ratio thereof is the same as described above.

In the above method [2], by reacting a polyisocyanate with the prepolymer obtained by the above method [1], an isocyanate group-containing prepolymer is obtained, by reacting a blocked polyisocyanate, a blocked isocyanate group-containing prepolymer is obtained, by reacting a polyepoxide, an epoxy group-containing prepolymer is obtained, and by reacting a polyacid anhydride, an acid anhydride group-containing prepolymer is obtained.

As to the amount of the compound containing a functional group and a reactive group to be used, for example, in the case of obtaining an isocyanate group-containing polyester prepolymer by reacting a polyisocyanate with a hydroxyl group-containing polyester, the proportion of the polyisocyanate is preferably from 5/1 to 1/1, more preferably from 4/1 to 1.2/1, and particularly preferably from 2.5/1 to 1.5/1 as expressed by the equivalent ratio [NCO]/[OH] of the isocyanate groups [NCO] to the hydroxyl groups [OH] of the hydroxyl group-containing polyester. Also in the case of a prepolymer having a different backbone or a different terminal group, only the constituent components vary but the ratio thereof is the same as described above.

The number of reactive groups contained in the reactive group-containing prepolymer (α) per molecule is preferably one or more, more preferably 1.5 to 3 on average, and particularly preferably 1.8 to 2.5 on average. Within the above ranges, the molecular weight of the cured product obtained by causing the prepolymer to react with the curing agent (β) is increased.

The Mn of the reactive group-containing prepolymer (α) is preferably 500 to 30,000, more preferably 1,000 to 20,000, and particularly preferably 2,000 to 10,000.

The Mw of the reactive group-containing prepolymer (α) is preferably 1,000 to 50,000, more preferably 2,000 to 40,000, and particularly preferably 4,000 to 20,000.

The viscosity of the reactive group-containing prepolymer (α) at 100° C. is preferably 200 Pa·s or less, more preferably 100 Pa·s or less. Controlling the viscosity to 200 Pa·s or less is preferable because a resin particle (X) having a narrow particle size distribution can be obtained.

Examples of the active hydrogen group-containing compound (β1) include a diamine (β1a) which optionally have been blocked with an eliminable compound, a diol (β1b), a dimercaptan (β1c), and water. Of these, (β1a), (β1b) and water are preferred, (β1a) and water are more preferred, and blocked polyamines and water are particularly preferred.

Examples of (β1a) include the same compounds disclosed for the diamine (3). Preferred as (β1a) are 4,4′-diaminodiphenylmethane, xylylenediamine, isophoronediamine, ethylenediamine, diethylenetriamine, triethylenetetramine, and mixtures thereof.

Examples of a polyamine blocked with an eliminable compound as (β1a) include a ketimine compound formed from the polyamine and a ketone having 3 to 8 carbon atoms (e.g., acetone, methyl ethyl ketone, and methyl isobutyl ketone), an aldimine compound obtained from an aldehyde compound having 2 to 8 carbon atoms (e.g., formaldehyde and acetaldehyde), an enamine compound, and an oxazolidine compound.

Examples of the diol (β1b) include compounds the same as the examples of the diol (1), and preferable examples are also the same.

Examples of the dimercaptan (β1c) include ethanedithiol, 1,4-butanedithiol, and 1,6-hexanedithiol.

A reaction terminator (βs) may, as necessary, be used together with the active hydrogen group-containing compound (β1). By use of the reaction terminator together with (β1) at a certain ratio, (A) can be controlled to have a prescribed molecular weight.

Examples of the reaction terminator (βs) include monoamines (e.g., diethylamine, dibutylamine, butylamine, laurylamine, monoethanolamine, and diethanolamine); blocked monoamines (e.g., ketimine compounds); monools (e.g., methanol, ethanol, isopropanol, butanol, and phenol); monomercaptans (e.g., butylmercaptan and laurylmercaptan); monoisocyanates (e.g., laurylisocyanate and phenylisocyanate); and monoepoxides (e.g., butyl glycidyl ether).

Examples of the active hydrogen-containing group (α2) possessed by the reactive group-containing prepolymer (α) in the above combination [2] include an amino group (α2a), a hydroxyl group (an alcoholic hydroxyl group and a phenolic hydroxyl group) (α2b), a mercapto group (α2c), a carboxyl group (α2d), and organic groups (α2e) obtained by blocking these groups with an eliminable compound. Preferred of these are (α2a), (α2b) and (α2e), and (α2b) is more preferred.

Examples of the organic group obtained by blocking an amino group with an eliminable compound include the same groups disclosed for the above-described (β1a).

Examples of the compound (β2) capable of reacting with an active hydrogen-containing group include a diisocyanate (β2a), a polyepoxide (β2b), a polycarboxylic acid (β2c), a polyacid anhydride (β2d), and a polyacid halide (β2e). Preferred of these are (β2a) and (β2b), and (β2a) is more preferred.

Examples of the diisocyanate (β2a) include the same compounds described for the diisocyanate (4), and preferred ones are also the same.

Examples of the diepoxide (β2b) include an aromatic diepoxy compound and an aliphatic diepoxy compound.

Examples of the aromatic diepoxy compound include glycidyl ethers of polyhydric phenols, glycidyl esters of aromatic polycarboxylic acids, glycidyl aromatic polyamines, and glycidylation products of aminophenols.

Examples of the glycidyl ethers of polyhydric phenols include bisphenol F diglycidyl ether, bisphenol A diglycidyl ether, bisphenol B diglycidyl ether, bisphenol AD diglycidyl ether, bisphenol S diglycidyl ether, halogenated bisphenol A diglycidyl ether, tetrachlorobisphenol A diglycidyl ether, catechin diglycidyl ether, resorcinol diglycidyl ether, hydroquinone diglycidyl ether, pyrogallol triglycidyl ether, 1,5-dihydroxynaphthalene diglycidyl ether, dihydroxybiphenyl diglycidyl ether, octachloro-4,4′-dihydroxybiphenyl diglycidyl ether, tetramethylbiphenyl diglycidyl ether, dihydroxynaphthylcresol triglycidyl ether, tris(hydroxyphenyl)methane triglycidyl ether, dinaphthyltriol triglycidyl ether, tetrakis(4-hydroxyphenyl)ethane tetraglycidyl ether, p-glycidylphenyldimethyltolyl bisphenol A glycidyl ether, trismethyl-tert-butyl-butylhydroxymethane triglycidyl ether, 9,9′-bis(4-hydroxyphenyl)fluorene diglycidyl ether, 4,4′-oxybis(1,4-phenylethyl)tetracresol glycidyl ether, 4,4′-oxybis(1,4-phenylethyl)phenyl glycidyl ether, bis(dihydroxynaphthalene) tetraglycidyl ether, glycidyl ether of a phenol or cresol novolak resin, glycidyl ether of a limonene phenol novolak resin, diglycidyl ether obtained through a reaction between bisphenol A (2 mol) and epichlorohydrin (3 mol), polyglycidyl ether of polyphenol obtained through a condensation reaction between phenol and glyoxal, glutaraldehyde, or formaldehyde, and polyglycidyl ether of polyphenol obtained through a condensation reaction between resorcin and acetone.

Examples of the glycidyl esters of aromatic polycarboxylic acids include diglycidyl phthalate, diglycidyl isophthalate, and diglycidyl terephthalate.

Examples of the glycidyl aromatic polyamines include N,N-diglycidylaniline, N,N,N′,N′-tetraglycidyl xylylene diamine and N,N,N′,N′-tetraglycidyldiphenylmethane diamine.

Examples of the aromatic polyepoxy compound include a diglycidyl urethane compound obtained through an addition reaction between tolylene diisocyanate or diphenylmethane diisocyanate, and glycidol, a glycidyl group-containing polyurethane (pre)polymer obtained by reacting the aforementioned two reaction products with polyol, and diglycidyl ether of bisphenol A-AO adduct.

Examples of the aliphatic polyepoxy compound include a linear aliphatic polyepoxy compound and a cyclic aliphatic polyepoxy compound.

Examples of the linear aliphatic polyepoxy compound include polyglycidyl ethers of polyhydric aliphatic alcohols, polyglycidyl esters of polyvalent fatty acids, and glycidyl aliphatic amines.

Examples of the polyglycidyl ethers of polyhydric aliphatic alcohols include ethylene glycol diglycidyl ether, propylene glycol diglycidyl ether, tetramethylene glycol diglycidyl ether, 1,6-hexanediol diglycidyl ether, polyethylene glycol diglycidyl ether, polypropylene glycol diglycidyl ether, polytetramethylene glycol diglycidyl ether, neopentyl glycol diglycidyl ether, trimethylolpropane polyglycidyl ether, glycerol polyglycidyl ether, pentaerythritol polyglycidyl ether, sorbitol polyglycidyl ether, and polyglycerol polyglycidyl ether.

Examples of the polyglycidyl esters of polyvalent fatty acids include diglycidyl oxalate, diglycidyl malate, diglycidyl succinate, diglycidyl glutarate, diglycidyl adipate, and diglycidyl pimelate.

Examples of the glycidyl aliphatic amines include N,N,N′,N′-tetraglycidylhexamethylenediamine.

Examples of the aliphatic polyepoxy compound include copolymers of diglycidyl ether and glycidyl (meth)acrylate.

Examples of the cyclic aliphatic polyepoxy compound include triglycidylmelamine, vinylcyclohexene dioxide, limonene dioxide, dicyclopentadiene dioxide, bis(2,3-epoxycyclopentyl) ether, ethylene glycol bisepoxydicyclopentyl ether, 3,4-epoxy-6-methylcyclohexylmethyl-3′,4′-epoxy-6′-methylcyc lohexane carboxylate, bis(3,4-epoxy-6-methylcyclohexylmethyl) adipate, bis(3,4-epoxy-6-methylcyclohexylmethyl) butylamine, and dimer acid diglycidyl ester.

Examples of the cyclic aliphatic polyepoxy compound include a hydrogenated product of the aforementioned aromatic polyepoxide compound.

Examples of the dicarboxylic acid (β2c) include the same compounds described for the dicarboxylic acid (2), and preferred ones are also the same.

The proportion of the curing agent (β), expressed by the ratio [α]/[β] of the equivalent [α] of the reactive groups in the reactive group-containing prepolymer (α) to the equivalent of the active hydrogen-containing groups [β] in the curing agent (β), is preferably from ½ to 2/1, more preferably from 1.5/1 to 1/1.5, and particularly preferably from 1.2/1 to 1/1.2. When the curing agent (β) is water, the water is dealt with as a divalent active hydrogen compound.

In the case where (A) is the crystalline vinyl resin (A3) and the monomers (5) to (14) are used as (A0), examples of a method for reacting the precursor (A0) to form (A) include a method including dispersing and suspending, in a dispersion medium (W), an oil phase containing an oil-soluble initiator and a monomer, and performing a radical polymerization reaction with heating.

Examples of the oil-soluble initiator include an oil-soluble peroxide-based polymerization initiator (I), and an oil-soluble azo-based polymerization initiator (II). The oil-soluble peroxide-based polymerization initiator (I) and a reducing agent may be used in combination to form a redox-based polymerization initiator (III). Moreover, two or more selected from (I) to (III) may be used in combination.

Oil-soluble peroxide-based polymerization initiator (I):

Acetyl peroxide, tert-butylperoxy-2-ethylhexanoate, benzoyl peroxide, parachlorobenzoyl peroxide, cumene peroxide, etc.

Oil-soluble azo-based polymerization initiator (II):

2,2′-Azobisisobutyronitrile, 2,2′-azobis-2,4-dimethylvaleronitrile, dimethyl-2,2′-azobis(2-methylpropionate), 2,2′-azobis(4-methoxy-2,4-dimethylvaleronitrile), etc.

Nonaqueous redox-based polymerization initiator (III):

A combination of an oil-soluble peroxide, such as a hydroperoxide, a dialkyl peroxide, and a diacyl peroxide, and an oil-soluble reducing agent, such as a tertiary amine, a naphthenate, a mercaptan, and an organic metal compound (e.g., triethyl aluminum, boron triethyl, and zinc diethyl).

In the method of the present invention for producing the resin particle (X), the crystalline polyurethane resin (B) preferably contains, in addition to the diol (1), a diol (1′) as constituent units thereof, the diol (1′) containing at least one group selected from the group consisting of a carboxylic acid salt group, a sulfonic acid salt group, a sulfamic acid salt group, and a phosphoric acid salt group. Inclusion of the diol (1′) as a constituent unit in (B) is preferable because this allows the resin particles (E) to easily disperse in a dispersion medium (F).

In the case where the crystalline polyurethane resin (B) contains, as a constituent unit thereof, the diol (1′) containing at least one group selected from the group consisting of a carboxylic acid salt group, a sulfonic acid salt group, a sulfamic acid salt group, and a phosphoric acid salt group, the method of the present invention for producing the resin particles (X) preferably includes, after a step of dispersing the solution (D) in the dispersion medium (F) in which resin particles (E) containing the crystalline polyurethane resin (B) are dispersed, a step of converting the group or groups of one or more members selected from the group consisting of a carboxylic acid salt group, a sulfonic acid salt group, a sulfamic acid salt group, and a phosphoric acid salt group contained in the resin particles (E) into a group or groups of one or more members selected from the group consisting of a carboxylic acid group, a sulfonic acid group, a sulfamic acid group, and a phosphoric acid group, respectively. Inclusion of such a step makes the resulting resin particle (X) improved in low-temperature fixability and water resistance.

The method for converting the group or groups of one or more members selected from the group consisting of a carboxylic acid salt group, a sulfonic acid salt group, a sulfamic acid salt group, and a phosphoric acid salt group contained in (E) into a group or groups of one or more members selected from the group consisting of a carboxylic acid group, a sulfonic acid group, a sulfamic acid group, and a phosphoric acid group, respectively, is not particularly restricted as long as there is used an acidic aqueous solution, which can be appropriately selected from among compounds known in the art, examples of which include an aqueous solution of hydrochloric acid, an aqueous solution of acetic acid, an aqueous solution of phosphoric acid, and an aqueous solution of nitric acid. These may be used individually or in combination. Among them, hydrochloric acid and phosphoric acid are preferable.

Examples of the organic solvent (C) for use in the present invention include: an aromatic hydrocarbon solvent (e.g., toluene, xylene, ethylbenzene, and tetralin); an aliphatic hydrocarbon solvent (e.g., n-hexane, n-heptane, n-decane, mineral spirit, and cyclohexane); a halogen solvent (e.g., methyl chloride, methyl bromide, methyl iodide, methylene dichloride, carbon tetrachloride, trichloroethylene, and perchloroethylene); an ester solvent (e.g., ethyl acetate, butyl acetate, methyl 2-hydroxyisobutyrate, methyl lactate, ethyl lactate, methoxybutyl acetate, methyl cellosolve acetate, ethyl cellosolve acetate, methyl pyruvate, and ethyl pyruvate); an ether solvent (e.g., diethyl ether, tetrahydrofuran, dioxane, dioxolane, ethyl cellosolve, butyl cellosolve, ethylene glycol monomethyl ether, ethylene glycol monoethyl ether, propylene glycol monomethyl ether, and propylene glycol monoethyl ether); a ketone solvent (e.g., acetone, methyl ethyl ketone, methyl isobutyl ketone, di-n-butyl ketone, and cyclohexanone): an alcohol solvent (e.g., methanol, ethanol, n-propanol, isopropanol, n-butanol, isobutanol, tert-butanol, 2-ethylhexyl alcohol, benzyl alcohol, 2,2,3,3-tetrafluoropropanol, and trifluoroethanol); an amide solvent (e.g., dimethyl formamide, and dimethyl acetamide); a sulfoxide solvent (e.g., dimethyl sulfoxide); a heterocyclic compound solvent (e.g., N-methylpyrrolidone); and a mixed solvent thereof. Moreover, a mixed solvent containing any of these organic solvent and an alcohol solvent or water may be used.

The solution (D) for use in the present invention is obtained by dissolving the crystalline resin (A) in the organic solvent (C).

The content of (A) in (D) is preferably 5 to 50% by weight, more preferably 10 to 40% by weight.

The content of (C) in (D) is preferably 50 to 95% by weight, more preferably 60 to 90% by weight.

The solution (D) may further contain an additive (e.g., a colorant, a charge controlling agent, an antioxidant, an antiblocking agent, a heat resistant stabilizer, and a fluidizing agent).

Any dyes, pigments, and the like used as coloring agents for toners may be used as the colorant. Specific examples thereof include carbon black, iron black, Sudan Black SM, Fast Yellow G, benzidine yellow, Solvent Yellow (21, 77, 114, etc.), Pigment Yellow (12, 14, 17, 83, etc.), Indofast Orange, Irgazin Red, p-nitroaniline red, toluidine red, Solvent Red (17, 49, 128, 5, 13, 22, 48.2, etc.), disperse red, Carmine FB, Pigment Orange R, Lake Red 2G, Rhodamine FB, Rhodamine B Lake, Methyl Violet B Lake, copper phthalocyanine blue, Solvent Blue (25, 94, 60, 15.3, etc.), Pigment Blue, brilliant green, phthalocyanine green, Oil Yellow GG, Kayaset YG, Orasol Brown B, and Oil Pink OP; these may be used individually or in combination.

The content of the colorant is preferably 0 to 15% by weight based on the weight of (A).

Examples of the charge controlling agent include a nigrosine dye, a triphenylmethane-based dye containing a tertiary amine as a side chain thereof, a quaternary ammonium salt, a polyamine resin, an imidazole derivative, a quaternary ammonium salt group-containing polymer, a metal-containing azo dye, a copper phthalocyanine dye, a salicylic acid metal salt, a boron complex of benzilic acid, a sulfonic acid group-containing polymer, a fluoropolymer, a halogen-substituted aromatic ring-containing polymer, a metal complex of an alkyl derivative of salicylic acid, and cetyltrimethylammonium bromide.

The content of the charge controlling agent is preferably 0 to 5% by weight based on the weight of (A).

Examples of the fluidizing agent include colloidal silica, alumina powder, titanium oxide powder, calcium carbonate powder, barium titanate, magnesium titanate, calcium titanate, strontium titanate, zinc oxide, quartz sand, clay, mica, wollastonite, diatom earth, chromium oxide, cerium oxide, rouge, antimony trioxide, magnesium oxide, zirconium oxide, barium sulfate, and barium carbonate.

The content of the fluidizing agent is preferably 0 to 10% by weight based on the weight of (A).

The resin particles (E) for use in the present invention contain the crystalline polyurethane resin (B).

The volume average particle diameter of (E) is preferably 0.01 to 0.5 μm, more preferably 0.02 to 0.4 μm, particularly preferably 0.03 to 0.3 μm, and most preferably 0.04 to 0.2 μm.

The resin particles (G) for use in the present invention contain the crystalline resin (A).

The volume average particle diameter of (G) is preferably 0.1 to 300 μm, more preferably 0.5 to 250 μm, and particularly preferably 1 to 200 μm.

The volume average particle diameters of the resin particles (E) and (G) can be measured with a laser particle size distribution analyzer, such as “LA-920” [manufactured by HORIBA, Ltd.] and “Multisizer III” [manufactured by Beckman Coulter, Inc.], or “ELS-800” [manufactured by Otsuka Electronics Co., Ltd.], which uses a laser Doppler method as an optical system. If there is a difference in the measured values between the aforementioned measuring devices, the value measured with “ELS-800” is used.

The volume average particle diameter of the resin particles (E) is typically smaller than the volume average particle diameter of the resin particles (G), and in view of uniformity in the particle diameter of the resin particles (X), the value of the particle diameter ratio [the volume average particle diameter of (E)]/[the volume average particle diameter of (G)] is preferably within the range of 0.001 to 0.3. The lower limit of the particle diameter ratio is more preferably 0.003, and the upper limit is more preferably 0.25. When the particle diameter ratio is greater than 0.3, (E) is not efficiently adsorbed on the surface of (G) and therefore the particle size distribution of the resulting resin particles (X) tends to be wider.

Examples of the dispersion medium (F) for use in the present invention include liquid or supercritical carbon dioxide (F1), a nonaqueous organic solvent (F2), and an aqueous medium (F3).

Among (F1), the liquid carbon dioxide is carbon dioxide having temperature and pressure conditions represented in a region in a phase diagram represented with temperature axis and pressure axes of the carbon dioxide, the region being surrounded by a gas-liquid boundary line passing through a triple point of carbon dioxide (temperature=−57° C., pressure=0.5 MPa) and a critical point of carbon dioxide (temperature=31° C., pressure=7.4 MPa), an isothermal line of the critical temperature, and a solid-liquid boundary line.

Among (F1), the supercritical carbon dioxide is carbon dioxide having temperature and pressure conditions equal to or higher than the critical temperature (with proviso that the pressure represents the total pressure in the case of a mixed gas composed of two or more components).

Examples of the nonaqueous organic solvent (F2) include an organic solvent in which the solubility of the crystalline resin (A) is 1% by weight or less among the aforementioned organic solvent (C). The solubility of (A) being 1% by weight or less is preferable because resin particles (X) are not readily cohered. The solubility of (A) in (F2) can be measured in the following method.

A nonaqueous dispersion liquid prepared by dispersing 10 g of (A) in 90 g of (F2) is subjected to centrifugal separation for 10 minutes at 3,000 rpm and about 2 g (wg) of a resulting supernatant liquid is collected in an aluminum container. Then, the supernatant liquid is dried in a vacuum dryer at a temperature equal to the boiling point of (C) for one hour, and then the mass of the residue is weighed. When the residue mass is Wg, the solubility of (A) in (F2) can be calculated from the following equation.

Solubility (% by weight)−[(W/w)/10]×100

The boiling point of (F2) is preferably 20° C. or more higher than the boiling point of the organic solvent (C) for use in the method for producing the resin particle (X) of the present invention. Use of such (F2) can prevent (F2) from being removed in the process of removing (C) by decompressing.

The aqueous medium (F3) is not particularly restricted as long as it is a liquid containing water as an essential constituent; examples of (F3) include a solution prepared by adding a surfactant to water.

As the surfactant, a conventional surfactant (e.g., the surfactant disclosed in JP-A-2004-124059) can be used.

On the other hand, there is also a case where (F3) preferably contains no surfactant in view of the cost of the resulting resin particle (X) and environmental load.

In the present invention, the step of, after the step of obtaining the dispersion (DF) by dispersing in the dispersion medium (F), obtaining the dispersion (DF) by dispersing, in the dispersion medium (F), the solution (D) obtained by removing the organic solvent (C) from the dispersion (DF) is not particularly restricted; for example, a method of dispersing (D) in (F) with a disperser can be mentioned.

The disperser is not particularly restricted as long as it is a disperser commonly on the market as an emulsifier or a disperser; examples thereof include a batch emulsifier (e.g., “Homogenizer” (manufactured by IKA), “POLYTRON” (manufactured by KINEMATICA AG.), and “TK Auto Homomixer” [manufactured by PRIMIX Corporation]), a continuous emulsifier (e.g., “Ebara Milder” [manufactured by Ebara Corporation], “TK FILMIX” and “TK Pipeline Homo Mixer” [manufactured by PRIMIX Corporation], “Colloid Mill” [manufactured by Shinko Pantech], “Slusher” and “Trigonal Wet Mill” [manufactured by Suntec Co., Ltd.], “Capitron” (manufactured by Eurotech), and “Fine Flow Mill” [manufactured by Pacific Machinery & Engineering Co., Ltd.]), a high pressure emulsifier (e.g., “Microfluidizer” [manufactured by MIZUHO INDUSTRIAL CO., LTD.], “Nanomizer” [manufactured by NANOMIZER Inc.], and “APV Gaulin” (manufactured by SPX Corporation)), a membrane emulsifier (e.g., “Membrane Emulsifier” [manufactured by REICA Co., Ltd.]), a vibration emulsifier (e.g., “Vibro Mixer” [manufactured by REICA Co., Ltd.]), and an ultrasonic emulsifier (e.g., “Ultrasonic Homogenizer” (manufactured by Branson Ultrasonics Corporation)).

Examples of the step of removing the organic solvent (C) from the dispersion (DF) include a method of removing it by decompression. When (C) is removed by decompression, the decompression degree and the temperature need to be controlled so that (E) may not be removed at the same time.

When (F) is (F1), (C) is condensed in (DF) as (C) is removed by decompression and, as a result, there may occur a problem that the resin particles (X) in (DF) are dissolved or the resin particles(X) are cohered to each other.

When (F) is (F1), therefore, a preferable method is that (F1) is further mixed in (DF) to extract (C) present in (X) into the phase of (DF), (DF) is then replaced with (F1), followed by decompressing (0.1 to 20 MPa).

When (F1) is further mixed in (DF), (F1) having a higher pressure than that of (DE) may be added or (DF) may be added to (F1) having a lower pressure than that of (DF), but the latter is preferable in view of the easiness of a continuous operation. Considering prevention of cohesion of (X), the amount of (F1) to be mixed with (DF) is preferably 1 to 50 times the volume of (DF), more preferably 1 to 40 times, and particularly preferably 1 to 30 times.

Examples of the method for replacing (DF) with (F1) include a method in which the resin particles (X) are temporally captured with a filter or a cyclone and then (F1) is passed until (C) is completely removed while maintaining the pressure. The amount of the (F1) to be passed is preferably 1 to 100 times the volume of (DE), more preferably 1 to 50 times, and most preferably 1 to 30 times in view of the easiness of the removal of (C).

When (F) is (F2) or (F3), the step of removing the organic solvent (C) from the dispersion (DF) may be a method of removing (C) by decompression (0.001 MPa to 0.050 MPa).

In the method of the present invention for producing the resin particles (X), the resin particles (X) can be separated from the dispersion medium (F) by performing a step of removing the dispersion medium (F) after the step of removing the organic solvent (C).

The method for removing (F) is not particularly restricted, and examples thereof include a method in which (F) is removed by decompression, and a method in which solid-liquid separation is performed by filtering and/or using a centrifugal separation device, followed by drying.

Since the resin particles (X) are obtained as a result of deposition of resin particles (E) to the surface of resin particles (G), (E) needs to have an adsorption power to (G).

The adsorption power of (E) to (G) can be controlled by the following methods.

(1) Designing (E) and (G) to have reverse electric charges to each other to generate an adsorption power. In this case, the adsorption power increases as the electric charges of (E) and (G) each increase.
(2) The adsorption power increases as a surfactant is used in the dispersion medium (F3).
(3) The adsorption power increases as the difference in SP value between the crystalline resin (A) and the crystalline polyurethane resin (B) is reduced.

In the method of the present invention for producing the resin particle (X), the particle shape or the particle surface configuration of (X) can be controlled by controlling the SP value difference between the crystalline resin (A) and the crystalline polyurethane resin (B) or the Mw of (A). When the SP value difference between (A) and (B) is small, (X) being irregular in shape and having smooth surfaces tends to be obtained. When the SP value difference is large, (X) being spherical and having rough surfaces tends to be obtained.

When the Mw of (A) is large, (X) having rough surfaces tends to be obtained. When the Mw of (A) is small, (X) having smooth surfaces tends to be obtained.

It should be noted that the excessively small or large SP value difference between (A) and (B) make granulation difficult. Moreover, an excessively small Mw of (A) makes granulation difficult.

Accordingly, the difference in SP value between (A) and (B) is preferably 0.01 to 5.0 (cal/cm³)^{1/2}, more preferably 0.1 to 3.0 (cal/cm³)^{1/2}, and particularly preferably 0.2 to 2.0 (cal/cm³)^{1/2}.

### EXAMPLES

The present invention is further described by examples below, but the invention is not limited thereto.

### Production Example 1

### Production of Crystalline Polyurethane Resin (B-1) Solution

A reaction vessel equipped with a stirrer and a thermometer was charged with 74 parts by weight of a polyester diol “NIPPOLAN 4073” [hydroxyl value=56, produced by Nippon Polyurethane Industry Co., Ltd.] composed of 1,6-hexanediol and adipic acid, 20 parts by weight of 1,9-nonanediol, 47 parts by weight of 2,2-dimethylolpropionic acid, 9 parts by weight of sodium 3-(2,3-dihydroxypropoxy)-1-propanesulfonate, 100 parts by weight of hexamethylene diisocyanate, 4 parts by weight of triethylamine and 250 parts by weight of acetone under introduction of nitrogen. Then, the temperature was raised to 50° C. and a urethanization reaction was carried out for 10 hours, thereby producing a solution of an isocyanate group-terminated urethane resin. Subsequently, 8 parts by weight of n-butylamine and 31 parts by weight of triethylamine were added and a reaction was carried out at 50° C. for 3 hours, affording an acetone solution of a crystalline polyurethane resin (B-1).

The NCO content of (B-1) was 0% by weight.

### Production Example 2

### Production of Crystalline Polyurethane Resin (B-2) Solution

A reaction vessel equipped with a stirrer and a thermometer was charged with 379.7 parts by weight of a polyester diol composed of ethylene glycol and sebacic acid (hydroxyl value=44), 26.9 parts by weight of 2,2-dimethylolpropionic acid, 2.4 parts by weight of N,N-bis(2-hydroxyethyl)sulfamic acid, 76 parts by weight of isophorone diisocyanate, and 500 parts by weight of acetone under introduction of nitrogen. Then, heat was added to 90° C. and a urethanization reaction was carried out for 40 hours, thereby producing an acetone solution of a hydroxyl group-terminated crystalline urethane resin (B-2). The NCO content of (B-2) was 0% by weight.

### Production Example 3

### Production of Crystalline Polyurethane Resin (B-3) Solution

A reaction vessel equipped with a stirrer and a thermometer was charged with 377.3 parts by weight of a polyester diol composed of 1,6-hexanediol and dodecanedicarboxylic acid (hydroxyl value=31), 30.3 parts by weight of 2,2-dimethylolpropionic acid, 2.4 parts by weight of bis(2-hydroxyethyl) phosphate, 95.0 parts by weight of isophorone diisocyanate, and 487.2 parts by weight of acetone under introduction of nitrogen. Then, heat was added to 90° C. and a urethanization reaction was carried out for 40 hours, thereby producing an acetone solution of a hydroxyl group-terminated crystalline urethane resin (B-3). The NCO content of (B-3) was 0% by weight.

### Production Example 4

### Production of Crystalline Polyurethane Resin (B-4) Solution

A reaction vessel equipped with a stirrer and a thermometer was charged with 447 parts by weight of a polyester diol composed of 1,12-dodecanediol, fumaric acid and terephthalic acid (hydroxyl value=51), 6.3 parts by weight of 2,2-dimethylolpropionic acid, 2.5 parts by weight of sodium 3-(2,3-dihydroxypropoxy)-1-propanesulfonate, 44 parts by weight of hexamethylene diisocyanate, and 500 parts by weight of acetone under introduction of nitrogen. Then, heat was added to 90° C. and a urethanization reaction was carried out for 40 hours, thereby producing an acetone solution of a hydroxyl group-terminated crystalline urethane resin (B-4). The NCO content of (B-4) was 0% by weight.

### Production Example 5

### Production of Prepolymer Solution for Crystalline Polyurethane Resin (B-5)

A reaction vessel equipped with a stirrer and a thermometer was charged with 99 parts by weight of a polyester diol “SANESTER 4620” [hydroxyl value=56, produced by Sanyo Chemical Industries, Ltd.] composed of 1,4-butanediol and adipic acid, 50 parts by weight of a polyester diol “SANESTER 4610” [hydroxyl value=112, produced by Sanyo Chemical Industries, Ltd.] composed of 1,4-butanediol and adipic acid, 50 parts by weight of 2,2-dimethylolpropionic acid, 17 parts by weight of N,N-bis(2-hydroxyethyl)sulfamic acid, 67 parts by weight of diphenylmethane diisocyanate, 3 parts by weight of triethylamine, and 250 parts by weight of acetone under introduction of nitrogen. Then, heat was added to 50° C. and a urethanization reaction was carried out for 10 hours, thereby producing an acetone solution of a prepolymer (80-5) to a crystalline urethane resin (B-5). The NCO content of (B0-5) was 1.7% by weight.

### Production Example 6

### Production of Crystalline Polyurethane Resin (B-6) Solution

A reaction vessel equipped with a stirrer and a thermometer was charged with 111 parts by weight of nonamethylenediol, 21 parts by weight of 2,2-dimethylolpropionic acid, 1 part by weight of sodium 3-(2,3-dihydroxypropoxy)-1-propanesulfonate, 117 parts by weight of hexamethylene diisocyanate, 15 parts by weight of triethylamine, and 250 parts by weight of acetone under introduction of nitrogen. Then, heat was added to 50° C. and a urethanization reaction was carried out for 15 hours, thereby producing a solution of a hydroxyl group-terminated crystalline urethane resin. The NCO content at the completion of the urethanization reaction was 0% by weight.

### Production Example 7

### Production of Crystalline Polyurethane Resin (B-7) Solution

A reaction vessel equipped with a stirrer and a thermometer was charged with 379.7 parts by weight of a polyester diol composed of ethylene glycol and sebacic acid (hydroxyl value=44), 26.9 parts by weight of 2,2-dimethylolpropionic acid, 2.4 parts by weight of N,N-bis(2-hydroxyethyl)sulfamic acid, 76 parts by weight of isophorone diisocyanate, and 500 parts by weight of acetone under introduction of nitrogen. Then, heat was added to 90° C. and a urethanization reaction was carried out for 40 hours, thereby producing an acetone solution of a hydroxyl group-terminated crystalline urethane resin (B-7). The NCO content of (B-7) was 0% by weight.

### Production Example 8

### Production of Crystalline Polyurethane Resin (B-8) Solution)

A reaction vessel equipped with a stirrer and a thermometer was charged with 379.7 parts by weight of a polyester diol composed of ethylene glycol and sebacic acid (hydroxyl value=44), 26.9 parts by weight of 2,2-dimethylolpropionic acid, 2.4 parts by weight of N,N-bis(2-hydroxyethyl)sulfamic acid, 76 parts by weight of isophorone diisocyanate, and 500 parts by weight of acetone under introduction of nitrogen. Then, heat was added to 90° C. and a urethanization reaction was carried out for 40 hours, thereby producing an acetone solution of a hydroxyl group-terminated crystalline urethane resin (B-8). The NCO content of (B-8) was 0% by weight.

### Production Example 9

### Production of Aqueous Dispersion Liquid (W-1) of Particulates (E-1)

A reaction vessel equipped with a stirrer, a thermometer, and a desolvating apparatus was charged with 1800 parts by weight of water and then the temperature was raised up to 40° C. Subsequently, 836 parts by weight of the acetone solution of (B-1) obtained in Production Example 1 that was controlled to 40° C. was charged under stirring to emulsify (B-1) in water and then acetone was evaporated, affording an aqueous dispersion liquid (W-1) of particulates (E-1) made of (B-1).

### Production Example 10

### Production of Aqueous Dispersion Liquid (W-2) of Particulates (E-2)

A reaction vessel equipped with a stirrer, a thermometer, and a desolvating apparatus was charged with 1800 parts by weight of water and then the temperature was raised up to 40° C. Subsequently, 836 parts by weight of the acetone solution of (B-2) obtained in Production Example 2 that was controlled to 40° C. was charged under stirring to emulsify (B-2) in water and then acetone was evaporated, affording an aqueous dispersion liquid (W-2) of particulates (E-2) made of (B-2).

### Production Example 11

### Production of Aqueous Dispersion Liquid (W-3) of Particulates (E-3)

A reaction vessel equipped with a stirrer, a thermometer, and a desolvating apparatus was charged with 1800 parts by weight of water and then the temperature was raised up to 40° C. Subsequently, 836 parts by weight of the acetone solution of (B-3) obtained in Production Example 3 that was controlled to 40° C. was charged under stirring to emulsify (B-3) in water and then acetone was evaporated, affording an aqueous dispersion liquid (W-3) of particulates (E-3) made of (B-3).

### Production Example 12

### Production of Aqueous Dispersion Liquid (W-4) of Particulates (E-4)

A reaction vessel equipped with a stirrer, a thermometer, and a desolvating apparatus was charged with 1800 parts by weight of water and then the temperature was raised up to 40° C. Subsequently, 836 parts by weight of the acetone solution of (B-4) obtained in Production Example 4 that was controlled to 40° C. was charged under stirring to emulsify (B-4) in water and then acetone was evaporated, affording an aqueous dispersion liquid (W-4) of particulates (E-4) made of (B-4).

### Production Example 13

### Production of Aqueous Dispersion Liquid (W-5) of Particulates (E-5)

A reaction vessel equipped with a stirrer, a thermometer, and a desolvating apparatus was charged with 1800 parts by weight of water and then the temperature was raised up to 40° C. Subsequently, 836 parts by weight of the acetone solution of (B-5) obtained in Production Example 5 that was controlled to 40° C. was charged under stirring to emulsify (B-5) in water, and moreover 4.5 parts by weight of n-butylamine, 9.5 parts by weight of hexamethylenediamine, and 10 parts by weight of triethylamine were added and allowed to react for 5 hours with stirring, and then acetone was evaporated, affording an aqueous dispersion liquid (W-5) of particulates (E-5) made of a resin resulting from amine extension of (B-5).

### Production Example 14

### Production of Aqueous Dispersion Liquid (W-6) of Particulates (E-6)

A reaction vessel equipped with a stirrer, a thermometer, and a desolvating apparatus was charged with 1800 parts by weight of water and then the temperature was raised up to 40° C. Subsequently, 836 parts by weight of the acetone solution of (B-6) obtained in Production Example 6 that was controlled to 40° C. was charged under stirring to emulsify (B-6) in water and then acetone was evaporated, affording an aqueous dispersion liquid (W-6) of particulates (E-6) made of (B-6).

### Production Example 15

### Production of Aqueous Dispersion Liquid (W-7) of Particulates (E-7)

A reaction vessel equipped with a stirrer, a thermometer, and a desolvating apparatus was charged with 18 parts by weight of a 48.5% by weight aqueous solution of sodium dodecyldiphenyl ether disulfonate “ELEMINOL MON-7” [produced by Sanyo Chemical Industries, Ltd.] and 1800 parts by weight of water, and then the temperature was raised up to 40° C. Subsequently, 836 parts by weight of the acetone solution of (B-7) obtained in Production Example 7 that was controlled to 40° C. was charged under stirring to emulsify (B-7) in water and then acetone was evaporated, affording an aqueous dispersion liquid (W-7) of particulates (E-7) made of (B-7).

### Production Example 16

### Production of Decane Dispersion Liquid (W-8) of Particulates (E-8)

A reaction vessel equipped with a stirrer, a thermometer, and a desolvating apparatus was charged with 1800 parts by weight of decane and then the temperature was raised up to 40° C. Subsequently, 836 parts by weight of the acetone solution of (B-8) obtained in Production Example 8 that was controlled to 40° C. was charged under stirring to emulsify (B-8) in water and then acetone was evaporated, affording a decane dispersion liquid (W-8) of particulates (E-8) made of (8-8).

### Comparative Production Example 1

### Production of Comparative Polyurethane Resin (B′-1) Solution

A reaction vessel equipped with a stirrer and a thermometer was charged with 197.5 parts by weight of a polyester diol composed of 1,2-propylene glycol and isophthalic acid (hydroxyl value=56), 10 parts by weight of 2,2-dimethylolpropionic acid, 2.5 parts by weight of sodium 3-(2,3-dihydroxypropoxy)-1-propanesulfonate, 40 parts by weight of isophorone diisocyanate, 8 parts by weight of triethylamine, and 250 parts by weight of acetone under introduction of nitrogen. Then, heat was added to 50° C. and a urethanization reaction was carried out for 15 hours, thereby producing an acetone solution of a hydroxyl group-terminated urethane resin (B′-1). The NCO content of (B′-1) was 0% by weight.

### Comparative Production Example 2

### Production of Comparative Polyurethane Resin (B′-2) Solution

A reaction vessel equipped with a stirrer and a thermometer was charged with 92 parts by weight of polyethylene glycol “PEG-400” [hydroxyl value=278, produced by Sanyo Chemical Industries, Ltd.], 38 parts by weight of 2,2-dimethylolpropionic acid, 3 parts by weight of sodium 3-(2,3-dihydroxypropoxy)-1-propanesulfonate, 122 parts by weight of isophorone diisocyanate, 3 parts by weight of triethylamine, and 250 parts by weight of acetone under introduction of nitrogen. Then, heat was added to 50° C. and a urethanization reaction was carried out for 15 hours, and subsequently 29 parts by weight of triethylamine was added and mixed, thereby producing an acetone solution of a urethane resin (B′-2). The NCO content of (B′-2) was 0% by weight.

### Comparative Production Example 3

### Production of Aqueous Dispersion Liquid (W′-1) of Particulates (E′-1)

A reaction vessel equipped with a stirrer, a thermometer, and a desolvating apparatus was charged with 1800 parts by weight of water and then the temperature was raised up to 40° C. Subsequently, 836 parts by weight of the acetone solution of (B′-1) obtained in Comparative Production Example 1 that was controlled to 40° C. was charged under stirring to emulsify (B′-1) in water and then acetone was evaporated, affording an aqueous dispersion liquid (W′-1) of particulates (E′-1) made of (B′-1). The volume average particle diameter of (E′-1) in (W′-1) was measured with “ELS-800” and it was 0.30 μm.

### Comparative Production Example 4

### Production of Aqueous Dispersion Liquid (W′-2) of Particulates (E′-2)

A reaction vessel equipped with a stirrer, a thermometer, and a desolvating apparatus was charged with 1800 parts by weight of water and then the temperature was raised up to 40° C. Subsequently, 836 parts by weight of the acetone solution of (B′-2) obtained in Comparative Production Example 2 that was controlled to 40° C. was charged under stirring to emulsify (B′-2) in water and then acetone was evaporated, affording an aqueous dispersion liquid (W′-2) of particulates (E′-2) made of (B′-2). The volume average particle diameter of (E′-2) in (W′-2) was measured with “ELS-800” and it was 0.30 μm.

As to the crystalline polyurethane resins (B-1) to (B-8) obtained in Production Examples 1 to 8, the polyurethane resins (B′-1) and (B′-2) obtained in Comparative Production Examples 1 to 2, the dispersion liquids (E-1) to (E-8) obtained in Production Examples 9 to 16, and the aqueous dispersion liquids (W′-1) and (W′-2) obtained in Comparative Production Examples 3 to 4, physical property values are given in Table 1. The volume average particle diameter of the particulates in an aqueous dispersion liquid was measured with “ELS-800” even if this is not explicitly stated in the text.

TABLE 1

| | (B), (B′) | | | | | | | | | |
|---|---|---|---|---|---|---|---|---|---|---|
| | (B-1) | (B-2) | (B-3) | (B-4) | (B-5) | (B-6) | (B-7) | (B-8) | (B′-1) | (B′-2) |
| Tu (°C.) | 53 | 67 | 79 | 85 | 70 | 75 | 67 | 67 | — | 36 |
| (B: urethane) (% by weight) | 25 | 7.6 | 7.4 | 5 | 2 | 32.9 | 7.6 | 7.6 | 8.5 | 25.9 |
| (B: urea) (% by weight) | 2.2 | 0.4 | 1.3 | 0.5 | 3 | 0 | 0.4 | 0.4 | 0 | 0 |
| (B: Mw) | 10,000 | 24,000 | 64,000 | 30,000 | 100,000 | 10,000 | 24,000 | 24,000 | 40,000 | 20,000 |
| Values of [Condition 2] | 19 | 6 | 19 | 5 | 27 | 25 | 6 | 6 | 12 | 22 |
| Acid value (gKOH/g) | 79 | 23 | 25 | 5 | 180 | 35 | 23 | 23 | 10 | 50 |
| Presence or absence of | Present | Present | Present | Present | Present | Absent | Present | Present | Present | Present |
| carboxylic acid (salt) group | | | | | | | | | | |
| Presence or absence | Present | Absent | Absent | Absent | Absent | Absent | Absent | Absent | Present | Present |
| of sulfonic acid (salt) group | | | | | | | | | | |
| Presence or absence | Absent | Present | Absent | Absent | Present | Absent | Present | Present | Absent | Absent |
| of sulfamic acid | | | | | | | | | | |
| (salt) group | | | | | | | | | | |
| Presence or absence of | Absent | Absent | Present | Absent | Absent | Present | Absent | Absent | Absent | Absent |
| phosphoric acid (salt) group | | | | | | | | | | |
| | (E), (E′) | | | | | | | | | |
| | (E-1) | (E-2) | (E-3) | (E-4) | (E-5) | (E-6) | (E-7) | (E-8) | (E′-1) | (E′-2) |
| Presence or absence of | Present | Present | Present | Present | Present | Absent | Present | Present | Present | Present |
| carbozylate | | | | | | | | | | |
| Presence or absence | Present | Absent | Absent | Absent | Absent | Absent | Absent | Absent | Present | Present |
| of sulfonate | | | | | | | | | | |
| Presence or absence | Absent | Present | Absent | Absent | Present | Absent | Present | Present | Absent | Absent |
| of sulfamate | | | | | | | | | | |
| Presence or absence | Absent | Absent | Present | Absent | Absent | Present | Absent | Absent | Absent | Absent |
| of phosphate | | | | | | | | | | |
| Volume average particle | 0.05 | 0.15 | 0.30 | 0.30 | 0.05 | 0.30 | 0.20 | 0.20 | 0.30 | 0.30 |
| diameter (μm) | | | | | | | | | | |
| | (W), (W′) | | | | | | | | | |
| | (W-1) | (W-2) | (W-3) | (W-4) | (W-5) | (W-6) | (W-7) | (W-8) | (W′-1) | (W′-2) |
| Presence or absence | Absent | Absent | Absent | Absent | Absent | Absent | Present | Absent | Absent | Absent |
| of activator | | | | | | | | | | |

### Production Example 17

### Synthesis of Crystalline Polyester Resin (A1-1)

A reaction vessel equipped with a stirrer, a thermometer, a nitrogen-inlet tube, and a decompression device was charged with 683 parts by weight of sebacic acid, 436 parts by weight of 1,6-hexanediol, and 0.1 parts by weight of dibutyltin oxide under introduction of nitrogen, and after replacing the atmosphere in the system with nitrogen by vacuum operation, the temperature was raised to 180° C. and stirring was continued at this temperature for 6 hours. Then, the temperature was gradually raised to 230° C. under reduced pressure (0.007 to 0.026 MPa) while the stirring was continued, and then the temperature was further maintained for 2 hours. On arrival at a viscous state, the reaction was stopped by cooling to 150° C., thereby affording a crystalline polyester resin (A1-1).

### Production Example 18

### Synthesis of Crystalline Polyester Resin (A1-2)

A crystalline polyester resin (A1-2) was obtained in the same manner as in Production Example 13 except that 683 parts by weight of sebacic acid was changed to a mixture of 703 parts by weight of sebacic acid and 56 parts by weight of adipic acid, and 436 parts by weight of 1,6-hexanediol was changed to 379 parts by weight of 1,4-butanediol.

### Production Example 19

### Synthesis of Crystalline Polyester Resin (A1-3)

A crystalline polyester resin (A1-3) was obtained in the same manner as in Production Example 13 except that 683 parts by weight of sebacic acid was changed to 713 parts by weight of adipic acid, and 436 parts by weight of 1,6-hexanediol was changed to 462 parts by weight of 1,4-butanediol.

### Production Example 20

### Synthesis of Crystalline Polyester Resin (A1-4)

A crystalline polyester resin (A1-4) was obtained in the same manner as in Production Example 13 except that the number of parts of sebacic acid was changed from 683 parts by weight to 848 parts by weight, and 436 parts by weight of 1,6-hexanediol was changed to a mixture of 226 parts by weight of ethylene glycol and 75 parts by weight of 1,4-butanediol.

### Production Example 21

### Synthesis of Crystalline Polyester Resin (A1-5)

A crystalline polyester resin (A1-5) was obtained in the same manner as in Production Example 13 except that 683 parts by weight of sebacic acid was changed to 627 parts by weight of isophthalic acid, and the number of parts of 1,6-hexanediol was changed from 436 parts by weight to 508 parts by weight.

### Production Example 22

### Synthesis of Crystalline Polyester Resin (A1-6)

A crystalline polyester resin (A1-6) was obtained in the same manner as in Production Example 13 except that the number of parts of sebacic acid was changed from 683 parts by weight to 787 parts by weight, and 436 parts by weight of 1,6-hexanediol was changed to 382 parts by weight of ethylene glycol.

### Production Example 23

### Production of Crystalline Polyurethane Resin (A2-1)

A reaction vessel equipped with a stirrer, a thermometer, a nitrogen-inlet tube, and a decompression device was charged with 216.0 parts by weight of the crystalline polyester (A1-2), 64.0 parts by weight of diphenylmethane diisocyanate, 20.0 parts by weight of 1,2-propylene glycol, and 300.0 parts by weight of tetrahydrofuran (THF) under introduction of nitrogen. Subsequently, the temperature was raised to 50° C., and a urethanization reaction was carried out for 15 hours at this temperature, thereby affording a THF solution of a hydroxyl group-terminated crystalline polyurethane resin (A2-1), and then THF was evaporated, affording the crystalline resin (A2-1). The NCO content of (A2-1) was 0% by weight.

### Production Example 24

### Production of Crystalline Polyurethane Resin (A2-2)

A reaction vessel equipped with a stirrer, a thermometer, a nitrogen-inlet tube, and a decompression device was charged with 150.0 parts by weight of the crystalline polyester (A1-3), 60.0 parts by weight of hexamethylene diisocyanate, 90.0 parts by weight of cyclohexane dimethanol, and 300.0 parts by weight of THF under introduction of nitrogen. Subsequently, the temperature was raised to 50° C., and a urethanization reaction was carried out for 15 hours at this temperature, thereby affording a THF solution of a hydroxyl group-terminated crystalline polyurethane resin (A2-2), and then THE was evaporated, affording the crystalline resin (A2-2). The NCO content of (A2-2) was 0% by weight.

### Production Example 25

### Production of Crystalline Polyurethane Resin (A2-3)

A reaction vessel equipped with a stirrer, a thermometer, a nitrogen-inlet tube, and a decompression device was charged with 285.0 parts by weight of the crystalline polyester (A1-4), 15.0 parts by weight of isophorone diisocyanate, and 300.0 parts by weight of THF under introduction of nitrogen. Subsequently, the temperature was raised to 50° C., and a urethanization reaction was carried out for 15 hours at this temperature, thereby affording a THF solution of a hydroxyl group-terminated crystalline polyurethane resin (A2-3), and then THF was evaporated, affording the crystalline resin (A2-3). The NCO content of (A2-3) was 0% by weight.

### Production Example 26

### Production of Crystalline Polyurethane Resin (A2-4)

A reaction vessel equipped with a stirrer, a thermometer, a nitrogen-inlet tube, and a decompression device was charged with 240.0 parts by weight of the crystalline polyester (A1-5), 33.0 parts by weight of diphenylmethane diisocyanate, 27.0 parts by weight of a bisphenol A·PO(2 mol) adduct, and 300.0 parts by weight of THF under introduction of nitrogen. Subsequently, the temperature was raised to 50° C., and a urethanization reaction was carried out for 15 hours at this temperature, thereby affording a THF solution of a hydroxyl group-terminated crystalline polyurethane resin (A2-4), and then THF was evaporated, affording the crystalline resin (A2-4). The NCO content of (A2-4) was 0% by weight.

### Production Example 27

### Production of Crystalline Polyurethane Resin (A2-5)

A reaction vessel equipped with a stirrer, a thermometer, a nitrogen-inlet tube, and a decompression device was charged with 240.0 parts by weight of the crystalline polyester (A1-6), 47.0 parts by weight of xylylene diisocyanate, 27.0 parts by weight of 1,2-propylene glycol, and 300.0 parts by weight of THF under introduction of nitrogen. Subsequently, the temperature was raised to 50° C., and a urethanization reaction was carried out for 15 hours at this temperature, thereby affording a THF solution of a hydroxyl group-terminated crystalline polyurethane resin (A2-5), and then THE was evaporated, affording the crystalline resin (A2-5). The NCO content of (A2-5) was 0% by weight.

### Production Example 28

### Synthesis of Precursor (A0-1)

A reaction vessel equipped with a stirrer, a heating and cooling device, a cooling tube, and a thermometer was charged with 452 parts by weight of (A1-1) and 500 parts by weight of ethyl acetate. The resulting mixture was heated to 60° C. and stirred for 2 hours at this temperature to dissolve (A1-1), and then water was added so that the water content in the solution might become 0.06% by weight. After confirming the dissolution of (A1-1), 48 parts by weight of tolylene diisocyanate was added, and the resulting mixture was heated to 80° C. and was allowed to react for 1 hour at this temperature, thereby affording an ethyl acetate solution of an isocyanate group-terminated precursor (A0-1). (A0-1) had an Mw of 14,000, a maximum peak temperature of heat of fusion of 60° C., and an isocyanate content of 1.0% by weight.

### Comparative Production Example 5

### Production of Polyester Resin (A′1-1)

A reaction vessel equipped with a stirrer, a thermometer, a nitrogen-inlet tube, and a decompression device was charged with 67 parts by weight of a bisphenol A·PO (2 mol) adduct, 700 parts by weight of a bisphenol A·PO (3 mol) adduct, 260 parts by weight of terephthalic acid, and 1 part by weight of dibutyltin oxide as a condensation catalyst. The resulting mixture was heated to 230° C. under atmospheric pressure and was allowed to react for 5 hours at this temperature. The resultant was further allowed to react for 2 hours under a reduced pressure of 0.013 MPa to 0.020 MPa. Subsequently, the resultant was cooled down to 180° C. and 24 parts by weight of trimellitic anhydride was added thereto. The resultant was allowed to react for 2 hours under atmospheric pressure in a sealed environment and was then cooled to room temperature, thereby affording a polyester resin (A′1-1).

As to the crystalline resins (A1-1), (A2-1) to (A2-5) and (A′1-1) obtained in Production Examples 17, 23 to 27 and Comparative Production Example 5, physical property values are given in Table 2.

TABLE 2

| | (A), (A′) | | | | | | |
|---|---|---|---|---|---|---|---|
| | (A1-1) | (A2-1) | (A2-2) | (A2-3) | (A2-4) | (A2-5) | (A′1-1) |
| Ta (° C.) | 70 | 60 | 45 | 63 | 50 | 65 | — |
| Total endotherm (J/g) | 150 | 60 | 40 | 80 | 40 | 120 | — |
| Content of (a) (% by weight) | 100 | 72 | 50 | 95 | 80 | 80 | 0 |
| Mw | 12,000 | 30,000 | 50,000 | 30,000 | 18,000 | 10,000 | 7,000 |
| Presence or absence of ester group | Present | Present | Present | Present | Present | Present | Present |
| Presence or absence of urethane group | Absent | Present | Present | Present | Present | Present | Absent |
| Presence or absence of urea group | Absent | Present | Present | Present | Present | Present | Absent |

### Production Example 29

### Production of Colorant Dispersion Liquid

A reaction vessel equipped with a stirrer, a heating and cooling device, a thermometer, a cooling tube, and a nitrogen-inlet tube was charged with 557 parts by weight (17.5 parts by mol) of propylene glycol, 569 parts by weight (7.0 parts by mol) of dimethyl terephthalate, 184 parts by weight (3.0 parts by mol) of adipic acid, and 3 parts by weight of tetrabutoxytitanate as a condensation catalyst, and these were caused to react with one another at 180° C. under a nitrogen gas flow for 8 hours while generated methanol being distilled off. Subsequently, a reaction was performed for 4 hours under a nitrogen gas flow while the temperature was gradually raised to 230° C. and generated propylene glycol and water were distilled off, and further the reaction was performed under a reduced pressure of 0.007 to 0.026 MPa for one hour. The recovered propylene glycol was 175 parts by weight (5.5 parts by mol). Subsequently, after cooling to 180° C., 121 parts by weight (1.5 parts by mol) of trimellitic anhydride was added, and after being allowed to react in a hermetically sealed condition under normal pressure for 2 hours, this was further caused to react at 220° C. under normal pressure until the softening point reached 180° C., affording a polyester resin (Mn=8,500).

A beaker was charged with 20 parts by weight of copper phthalocyanine blue, 4 parts by weight of a colorant dispersant “SOLSPERSE 28000” [produced by Avecia], 20 parts by weight of the polyester resin obtained, and 56 parts by weight of ethyl acetate, which were then uniformly dispersed by stirring, and subsequently copper phthalocyanine blue was microdispersed with a bead mill, affording a colorant dispersion liquid. The volume average particle diameter of the colorant dispersion liquid measured with “LA-920” was 0.2 μm.

### Production Example 30

### Production of Modified Wax

A pressure-resistant reaction vessel equipped with a stirrer, a heating and cooling device, a thermometer, and a dropping cylinder was charged with 454 parts by weight of xylene and 150 parts by weight of a low molecular weight polyethylene “SANWAX LEL-400” [softening point: 128° C., produced by Sanyo Chemical Industries, Ltd.]. After replacement with nitrogen, the temperature was raised to 170° C. under stirring and then a mixed solution of 595 parts by weight of styrene, 255 parts by weight of methyl methacrylate, 34 parts by weight of di-tert-butyl peroxyhexahydroterephthalate, and 119 parts by weight of xylene was dropped for 3 hours at that temperature, and then the resultant was held at the same temperature for 30 minutes. Subsequently, xylene was distilled off under a reduced pressure of 0.039 MPa, affording a modified wax. The graft chain of the modified wax had an SP value of 10.35 (cal/cm³)¹², an Mn of 1,900, an Mw of 5,200, and a Tg of 56.9° C.

### Production Example 31

### Production of Releasing Agent Dispersion Liquid

A reaction vessel equipped with a stirrer, a heating and cooling device, a cooling tube, and a thermometer was charged with 10 parts by weight of paraffin wax “HNP-9” [the maximum peak temperature of heat of fusion: 73° C., manufactured by NIPPON SEIRO CO., LTD.], 1 part by weight of the modified wax obtained in Production Example 30, and 33 parts by weight of ethyl acetate, which were then heated to 78° C. with stirring, stirred at this temperature for 30 minutes, and then cooled down to 30° C. for 1 hour, thereby crystallizing and depositing paraffin wax into the shape of particulates, which were further subjected to wet pulverization by means of ULTRA VISCOMILL (manufactured by ATMEX CO., Ltd.), affording a releasing agent dispersion liquid. The volume average particle diameter was 0.25 μm.

### Production Example 32

### Production of Resin Solution (D-1)

A reaction vessel equipped with a stirrer and a thermometer was charged with 30 parts by weight of the colorant dispersion liquid, 140 parts by weight of the releasing agent dispersion liquid, 100 parts by weight of the crystalline resin (A1-1), and 153 parts by weight of ethyl acetate, which were then stirred to homogeneously dissolve (A1-1), affording a resin solution (D-1).

### Production Example 33

### Production of Resin Solution (D-2)

A reaction vessel equipped with a stirrer and a thermometer was charged with 30 parts by weight of the colorant dispersion liquid, 140 parts by weight of the releasing agent dispersion liquid, 100 parts by weight of the crystalline resin (A2-1), and 153 parts by weight of ethyl acetate, which were then stirred to homogeneously dissolve (A2-1), affording a resin solution (D-2).

### Production Example 34

### Production of Resin Solution (D-3)

A reaction vessel equipped with a stirrer and a thermometer was charged with 30 parts by weight of the colorant dispersion liquid, 140 parts by weight of the releasing agent dispersion liquid, 100 parts by weight of the crystalline resin (A2-2), and 153 parts by weight of ethyl acetate, which were then stirred to homogeneously dissolve (A2-2), affording a resin solution (D-3).

### Production Example 35

### Production of Resin Solution (D-4)

A reaction vessel equipped with a stirrer and a thermometer was charged with 30 parts by weight of the colorant dispersion liquid, 140 parts by weight of the releasing agent dispersion liquid, 100 parts by weight of the crystalline resin (A2-3), and 153 parts by weight of ethyl acetate, which were then stirred to homogeneously dissolve (A2-3), affording a resin solution (D-4).

### Production Example 36

### Production of Resin Solution (D-5)

A reaction vessel equipped with a stirrer and a thermometer was charged with 30 parts by weight of the colorant dispersion liquid, 140 parts by weight of the releasing agent dispersion liquid, 100 parts by weight of the crystalline resin (A2-4), and 153 parts by weight of ethyl acetate, which were then stirred to homogeneously dissolve (A2-4), affording a resin solution (D-5).

### Production Example 37

### Production of Resin Solution (D-6)

A reaction vessel equipped with a stirrer and a thermometer was charged with 30 parts by weight of the colorant dispersion liquid, 140 parts by weight of the releasing agent dispersion liquid, 100 parts by weight of the crystalline resin (A1-1), and 153 parts by weight of tetrahydrofuran, which were then stirred to homogeneously dissolve (A1-1), affording a resin solution (D-6).

### Production Example 38

### Production of Resin Solution (D-7)

A reaction vessel equipped with a stirrer and a thermometer was charged with 30 parts by weight of the colorant dispersion liquid, 140 parts by weight of the releasing agent dispersion liquid, 50 parts by weight of the crystalline resin (A1-1), 50 parts by weight of the crystalline resin (A2-4), and 153 parts by weight of methyl ethyl ketone, which were then stirred to homogeneously dissolve (A1-1) and (A2-4), affording a resin solution (D-7).

### Production Example 39

### Production of Resin Solution (D-8)

A reaction vessel equipped with a stirrer and a thermometer was charged with 30 parts by weight of the colorant dispersion liquid, 140 parts by weight of the releasing agent dispersion liquid, 50 parts by weight of the crystalline resin (A2-1), 50 parts by weight of the crystalline resin (A2-5), and 153 parts by weight of acetone, which were then stirred to homogeneously dissolve (A2-1) and (A2-5), affording a resin solution (D-8).

### Production Example 40

### Production of Resin Solution (D-9)

A reaction vessel equipped with a stirrer and a thermometer was charged with 30 parts by weight of the colorant dispersion liquid, 140 parts by weight of the releasing agent dispersion liquid, 80 parts by weight of the crystalline resin (A2-1), 40 parts by weight of the precursor (A0-1), and 133 parts by weight of ethyl acetate, which were then stirred to homogeneously dissolve (A2-1) and (A0-1), affording a resin solution (D-9).

### Comparative Production Example 6

### Production of Resin Solution (D′-1)

A reaction vessel equipped with a stirrer and a thermometer was charged with 30 parts by weight of the colorant dispersion liquid, 140 parts by weight of the releasing agent dispersion liquid, 100 parts by weight of the polyester resin (A′1-1), and 153 parts by weight of ethyl acetate, which were then stirred to homogeneously dissolve (A′1-1), affording a resin solution (D′-1).

The compositions of the resin solutions (D-1) to (D-9) and (D′-1) obtained in Production Examples 32 to 40 and Comparative Production Example 6, respectively, are presented in Table 3.

TABLE 3

| Solution | | (D-1) | (D-2) | (D-3) | (D-4) | (D-5) | (D-6) | (D-7) | (D-8) | (D-9) | (D′-1) |
|---|---|---|---|---|---|---|---|---|---|---|---|
| Colorant dispersion liquid | | 30 | 30 | 30 | 30 | 30 | 30 | 30 | 30 | 30 | 30 |
| Releasing agent dispersion | | 140 | 140 | 140 | 140 | 140 | 140 | 140 | 140 | 140 | 140 |
| liquid | | | | | | | | | | | |
| Crystalline | (A1-1) | 100 | — | — | — | — | 100 | 50 | — | — | — |
| resin (A) | (A2-1) | — | 100 | — | — | — | — | — | 50 | 80 | — |
| | (A2-2) | — | — | 100 | — | — | — | — | — | — | — |
| | (A2-3) | — | — | — | 100 | — | — | — | — | — | — |
| | (A2-4) | — | — | — | — | 100 | — | 50 | — | — | — |
| | (A2-5) | — | — | — | — | — | — | — | 50 | — | — |
| (A′1-1) | | — | — | — | — | — | — | — | — | — | 100 |
| Precursor (A0) | (A0-1) | — | — | — | — | — | — | — | — | 40 | — |
| Organic | Ethyl acetate | 153 | 153 | 153 | 153 | 153 | — | — | — | 133 | 153 |
| solvent (C) | Acetone | — | — | — | — | — | — | — | 153 | — | — |
| | Methyl ethyl | — | — | — | — | — | — | 153 | — | — | — |
| | ketone | | | | | | | | | | |
| | Tetrahydrofuran | — | — | — | — | — | 153 | — | — | — | — |

### Example 1

A beaker was charged with 170.2 parts by weight of ion exchange water (F3), 0.3 parts by weight of (W-3), 1 part by weight of sodium carboxymethylcellulose, 36 parts by weight of a 48.5% by weight aqueous solution of sodium dodecyldiphenyl ether disulfonate “ELEMINOL MON-7” [produced by Sanyo Chemical Industries, Ltd.], and 15.3 parts by weight of ethyl acetate, which were then stirred to dissolve uniformly. Subsequently, the temperature was raised to 50° C. and 75 parts by weight of the resin solution (D-1) was charged at that temperature under stirring with a TK autohomomixer at 10,000 rpm and was stirred for 2 minutes. Subsequently, this mixed liquid was transferred to a reaction vessel equipped with a stirrer and a thermometer, and ethyl acetate was evaporated at 50° C. until the concentration became 0.5% by weight or less, affording an aqueous resin dispersion of resin particles (X-1) in which a shell layer (S) made of (B) was deposited on the surface of a core layer (Q) composed of (A). Subsequently, the aqueous resin dispersion was subjected to washing, filtering, and drying at 40° C. for 18 hours to control the volatile content to 0.5% by weight or lower, affording resin particles (X−1).

### Example 2

Resin particles (X-2) were obtained in the same manner as in Example 1 except that 75 parts by weight of the resin solution (D-1) was changed to 75 parts by weight of the resin solution (D-2) and 0.3 parts by weight of (W-3) was changed to 2.1 parts by weight of (W-2).

### Example 3

Resin particles (X-3) were obtained in the same manner as in Example 1 except that 75 parts by weight of the resin solution (D-1) was changed to 75 parts by weight of the resin solution (D-3) and 0.3 parts by weight of (W-3) was changed to 7.2 parts by weight of (W-2).

### Example 4

Resin particles (X-4) were obtained in the same manner as in Example 1 except that 75 parts by weight of the resin solution (D-1) was changed to 75 parts by weight of the resin solution (D-4) and 0.3 parts by weight of (W-3) was changed to 34.5 parts by weight of (W-2).

### Example 5

Resin particles (X-5) were obtained in the same manner as in Example 1 except that 75 parts by weight of the resin solution (D-1) was changed to 75 parts by weight of the resin solution (D-5) and 0.3 parts by weight of (W-3) was changed to 4.2 parts by weight of (W-1).

### Example 6

Resin particles (X-6) were obtained in the same manner as in Example 1 except that 15.3 parts by weight of ethyl acetate was changed to 15.3 parts by weight of tetrahydrofuran, 75 parts by weight of the resin solution (D-1) was changed to 75 parts by weight of the resin solution (D-6), and 0.3 parts by weight of (W-3) was changed to 4.2 parts by weight of (W-6).

### Example 7

Resin particles (X-7) were obtained in the same manner as in Example 1 except that 15.3 parts by weight of ethyl acetate was changed to 15.3 parts by weight of methyl ethyl ketone, 75 parts by weight of the resin solution (D-1) was changed to 75 parts by weight of the resin solution (D-7), and 0.3 parts by weight of (W-3) was changed to 4.2 parts by weight of (W-5).

### Example 8

Resin particles (X-8) were obtained in the same manner as in Example 1 except that 15.3 parts by weight of ethyl acetate was changed to 15.3 parts by weight of acetone, 75 parts by weight of the resin solution (D-1) was changed to 75 parts by weight of the resin solution (D-8), and 0.3 parts by weight of (W-3) was changed to 4.2 parts by weight of (W-4).

### Example 9

A beaker was charged with 170.2 parts by weight of ion exchange water (F3), 2.1 parts by weight of (W-2), 1 part by weight of sodium carboxymethylcellulose, 36 parts by weight of a 48.5% by weight aqueous solution of sodium dodecyldiphenyl ether disulfonate “ELEMINOL MON-7” [produced by Sanyo Chemical Industries, Ltd.], and 15.3 parts by weight of ethyl acetate, which were then stirred to dissolve uniformly. Subsequently, the temperature was raised to 50° C. and 75 parts by weight of the resin solution (D-9) was charged at that temperature under stirring with a TK autohomomixer at 10,000 rpm and was stirred for 2 minutes. Subsequently, this mixed liquid was transferred to a reaction vessel equipped with a stirrer and a thermometer, and ethyl acetate was evaporated at 50° C. until the concentration became 0.5% by weight or less, affording an aqueous resin dispersion of resin particles (X-9) in which a shell layer (S) made of (B) was deposited on the surface of a core layer (Q) composed of (A). Subsequently, the aqueous resin dispersion of (X−1) was subjected to acid washing with a 0.1 mol/L aqueous hydrochloric acid solution until the pH thereof became 2.1, filtering, and drying at 40° C. for 18 hours to control the volatile content to 0.5% by weight or lower, affording resin particles (X-9).

### Example 10

Resin particles (X-10) were obtained in the same manner as in Example 1 except that 75 parts by weight of the resin solution (D-1) was changed to 75 parts by weight of the resin solution (D-9) and 0.3 parts by weight of (W-3) was changed to 2.1 parts by weight of (W-7).

### Example 11

A beaker was charged with 108 parts by weight of decane and 2.1 parts by weight of (W-8), and the resultant was stirred to homogeneously dissolve. Subsequently, the temperature was raised to 50° C. and 75 parts by weight of the resin solution (D-9) was charged at that temperature under stirring with a TK autohomomixer at 10,000 rpm and was stirred for 2 minutes. Subsequently, this mixed liquid was transferred to a reaction vessel equipped with a stirrer and a thermometer, and ethyl acetate was evaporated at 50° C. until the concentration became 0.5% by weight or less, affording a dispersion of resin particles (X-11) in which a shell layer (S) made of (B) was deposited on the surface of a core layer (Q) composed of (A). Subsequently, the dispersion was subjected to washing, filtering, and drying at 40° C. for 18 hours to control the volatile content to 0.5% by weight or lower, affording resin particles (X-11).

### Comparative Example 1

Resin particles (X′-1) were obtained in the same manner as in Example 1 except that 75 parts by weight of the resin solution (D-1) was changed to 75 parts by weight of the resin solution (D′-1) and 0.3 parts by weight of (W-3) was changed to 4.2 parts by weight of (W-2).

### Comparative Example 2

Resin particles (X′-2) were obtained in the same manner as in Example 1 except that 75 parts by weight of the resin solution (D-1) was changed to 75 parts by weight of (D′-1) and 0.3 parts by weight of (W-3) was changed to 4.2 parts by weight of (W′-1).

### Comparative Example 3

Resin particles (X′-3) were obtained in the same manner as in Example 1 except that 75 parts by weight of the resin solution (D-1) was changed to 75 parts by weight of the resin solution (D-2) and 0.3 parts by weight of (W-3) was changed to 4.2 parts by weight of (W′-2).

The composition ratios (% by weight) of (Q), (Q′), (S), (S′) of each of the resin particles (X−1) to (X-11) and (X′-1) to (X′-3) are presented in Table 4. Resin particles (X−1) to (X-11) and (X′-1) to (X′-3) were subjected to measurement of a volume average particle diameter and particle size distribution and were subjected to evaluation of heat resistant storage stability, low-temperature fixability, heat adhesion, adhesion strength, glossiness of a coating film, and water resistance of a coating film. The results are presented in Tables 4 and 5.

### [1] Volume Average Particle Diameter, Particle Size Distribution

The resin particles (X-1) to (X-11) and (X′-1) to (X′-3) were each dispersed in water and subjected to measurement of a volume average particle diameter and particle size distribution by means of a Coulter Counter “Multisizer III” (manufactured by Beckman Coulter, Inc.).

### [2] Heat Resistant Storage Stability

The resin particles (X-1) to (X-11) and (X′-1) to (X′-3) were each left to stand in an atmosphere of 40° C. for one day, and then the degree of blocking was visually judged. The heat resistant storage stability was evaluated on the basis of the following criteria.

[Evaluation criteria]
◯: No blocking occurred.
x: Blocking occurred.

### [3] Low-Temperature Fixability

To each of the resin particles (X-1) to (X-11) and (X′-1) to (X′-3), 1.0% by weight of “Aerosil R972” [produced by Nippon Aerosil Co., Ltd.] is added and fully mixed to become uniform. Thereafter, the resulting powder is placed on paper uniformly in an amount of 0.6 mg/cm² (in the method for placing the powder on paper, a printer with its heat fixing device having been removed is used; any other method may be used as long as it can uniformly place the powder in the aforementioned weight density). The temperature at which cold offset occurred was measured when the paper was passed through pressure rollers under the condition represented by a fixing speed (heat roller rim speed) of 213 mm/sec and a fixing pressure (the pressure of the pressure roller) of 10 kg/cm². A lower temperature at which cold offset occurred means that low-temperature fixability is better.

### [4] Heat Adhesion

Resin particles (X-1) to (X-11) and (X′-1) to (X′-3) were electrostatically applied to a zinc phosphate-treated steel standard plate [produced by Nippon Testpanel Co., Ltd] to achieve a film thickness of 40 to 60 μm with a commercially available corona charge spray gun, baked at 100° C. for 20 minutes, and then subjected to a shear adhesion test in accordance with the method specified in JIS K6830. The heat adhesion was evaluated on the basis of the criteria shown below.

### [Evaluation Criteria]

◯: Aggregation fracture
x: Interface fracture

### [5] Adhesion Strength

Using an image fixed at 160° C. selected from among the samples for the above-described evaluation of the low-temperature fixability, a pencil hardness test was performed in accordance with the method specified in JIS K5600-5-4, and the adhesion strength or bonding strength was evaluated on the basis of the following criteria.

### [Evaluation Criteria]

⊙: HB or harder

### ◯: 4B to B

Δ: 5B or softer

### [6] Gloss of Coating Film

The gloss of an image fixed at 160° C. selected from among the samples for the above-described evaluation of the low-temperature fixability was visually judged, and the gloss of a coating film was evaluated on the basis of the following criteria.

### [Evaluation Criteria]

◯: Sufficient gloss is possessed.
Δ: Gloss is possessed.
x: Gloss is insufficient.

### [7] Water Resistance of Coating Film

An image fixed at 160° C. selected from among the samples used for the evaluation of low-temperature fixability was cut into a size of 4 cm×4 cm and then immersed for one hour in a red ink “PILOT INK/RED” [manufactured by PILOT CORPORATION] diluted 100 fold with water, and thereafter the distance of ink penetration from the edge was measured, and its maximum value (mm) was determined as a measure of water resistance. A smaller value thereof means better water resistance.

TABLE 4

| | | | | | | | | | | Example | Example |
|---|---|---|---|---|---|---|---|---|---|---|---|
| | Example 1 | Example 2 | Example 3 | Example 4 | Example 5 | Example 6 | Example 7 | Example 8 | Example 9 | 10 | 11 |
| Resin particle | (X-1) | (X-2) | (X-3) | (X-4) | (X-5) | (X-6) | (X-7) | (X-8) | (X-9) | (X-10) | (X-11) |
| Solution (D) | (D-1) | (D-2) | (D-3) | (D-4) | (D-5) | (D-6) | (D-7) | (D-8) | (D-9) | (D-9) | (D-9) |
| Weight ratio of | 99.8 | 98.5 | 95 | 80 | 97 | 97 | 97 | 97 | 98.5 | 98.5 | 98.5 |
| core layer (Q) | | | | | | | | | | | |
| Crystalline | (B-3) | (B-2) | (B-2) | (B-2) | (B-1) | (B-6) | (B-5) | (B-4) | (B-2) | (B-7) | (B-8) |
| polyurethane | | | | | | | | | | | |
| resin (B) | | | | | | | | | | | |
| Weight ratio | 0.2 | 1.5 | 5 | 20 | 3 | 3 | 3 | 3 | 1.5 | 1.5 | 1.5 |
| of shell | | | | | | | | | | | |
| layer (S) | | | | | | | | | | | |
| Tu (° C.) | 79 | 67 | 67 | 67 | 53 | 75 | 70 | 85 | 67 | 67 | 67 |
| Ta (° C.) | 70 | 60 | 45 | 63 | 50 | 70 | 60 | 62.5 | 60 | 60 | 60 |
| Tu − Ta (° C.) | 9 | 7 | 22 | 4 | 3 | 5 | 10 | 23 | 7 | 7 | 7 |
| Volume | 20 | 5.0 | 6.0 | 4.0 | 6.0 | 6.0 | 5.5 | 5.4 | 5.4 | 5.7 | 6.0 |
| average particle | | | | | | | | | | | |
| diameter (μm) | | | | | | | | | | | |
| Particle size | 1.20 | 1.15 | 1.11 | 1.16 | 1.13 | 1.15 | 1.12 | 1.17 | 1.17 | 1.19 | 1.20 |
| distribution | | | | | | | | | | | |
| Step of | X | X | X | X | X | X | X | X | X | X | X |
| converting acid | | | | | | | | | | | |
| Heat resistant | ◯ | ◯ | ◯ | ◯ | ◯ | ◯ | ◯ | ◯ | ◯ | ◯ | ◯ |
| storage stability | | | | | | | | | | | |
| Low-temperature | 110 | 100 | 90 | 100 | 95 | 105 | 105 | 110 | 110 | 110 | 110 |
| fixability (° C.) | | | | | | | | | | | |
| Heat adhesion | ◯ | ◯ | ◯ | ◯ | ◯ | ◯ | ◯ | ◯ | ◯ | ◯ | ◯ |
| Adhesion strength | ⊚ | ⊚ | ◯ | ◯ | ◯ | ⊚ | ⊚ | ⊚ | ⊚ | ⊚ | ⊚ |
| Gloss of | ◯ | ◯ | ◯ | ◯ | ◯ | ◯ | ◯ | ◯ | ◯ | ◯ | ◯ |
| coating film | | | | | | | | | | | |
| Water resistance | 1 | 1 | 1 | 1 | 1 | 1 | 1 | 1 | 1 | 1 | 1 |
| of coating | | | | | | | | | | | |
| film (mm) | | | | | | | | | | | |

TABLE 5

| | Comparative | Comparative | Comparative |
|---|---|---|---|
| | Example 1 | Example 2 | Example 3 |
| Resin particle | (X′-1) | (X′-2) | (X′-3) |
| Solution (D) | (D′-1) | (D′-1) | (D-2) |
| Weight ratio of core layer (Q) | 97 | 97 | 97 |
| Crystalline polyurethane | (B-2) | (B′-1) | (B′-2) |
| resin (B) | | | |
| Weight ratio of shell layer (S) | 3 | 3 | 3 |
| Tu (° C.) | 67 | — | 36 |
| Ta (° C.) | — | — | 60 |
| Tu − Ta (° C.) | — | — | −24 |
| Volume average particle | 5.5 | 6.0 | 11.0 |
| diameter (μm) | | | |
| Particle size distribution | 1.20 | 1.20 | 1.54 |
| Step of converting acid | X | X | X |
| Heat resistant storage | ◯ | X | X |
| stability | | | |
| Low-temperature fixability | 130 | 130 | 140 |
| (° C.) | | | |
| Heat adhesion | X | X | X |
| Adhesion strength | Δ | ◯ | Δ |
| Gloss of coating film | Δ | X | X |
| Water resistance of coating | 2 | 3 | 2 |
| film (mm) | | | |

### INDUSTRIAL APPLICABILITY

The resin particle (X) of the present invention is excellent in heat adhesion, low-temperature fixability, and heat resistant storage stability and high in adhesion strength, and a coating film obtained from the resin particle is high in glossiness and the coating film is excellent in water resistance. Therefore, the resin particle is useful as a base particle of an electrophotographic toner, an additive for paint, an additive for cosmetics, an additive for paper coating, a resin for slush molding, powder paint, a spacer for electronic parts production, a standard particle for an electronic measuring device, a particle for electronic paper, a carrier for medical diagnosis, a particle for electroviscosity, and resin particles for other molding applications.

1. A resin particle having a shell layer (S) containing a crystalline polyurethane resin (B) on the surface of a core layer (Q) containing a crystalline resin (A), wherein the maximum peak temperature (Ta) of the heat of fusion of the crystalline resin (A) is 40 to 70° C. and the maximum peak temperature (Tu) of the heat of fusion of the crystalline polyurethane resin (B) is 50 to 90° C.

2. The resin particle according to claim 1, wherein the resin particle fulfills the following condition 1:
0≦(Tu)−(Ta)≦30 [Condition 1].

3. The resin particle according to claim 1, wherein the crystalline polyurethane resin (B) fulfills the following condition 2:
0.94×(B:urethane)+0.70×(B:urea)+0.00032×(B:Mw)−9.2≧5 [Condition 2]
wherein (B:urethane) denotes the urethane group concentration (% by weight) of (B), (B:urea) denotes the urea group concentration (% by weight) of (B), and (B:Mw) denotes the Mw of (B).

4. The resin particle according to claim 1, wherein the acid value of the crystalline polyurethane resin (B) is 5 to 200 mgKOH/g.

5. The resin particle according to claim 1, wherein the crystalline polyurethane resin (B) has one or more members selected from the group consisting of a carboxylic acid group, a sulfonic acid group, a sulfamic acid group, a phosphoric acid group, a carboxylic acid salt group, a sulfonic acid salt group, a sulfamic acid salt group, and a phosphoric acid salt group.

6. The resin particle according to claim 1, wherein the weight ratio of the core layer (Q) to the shell layer (S) is from 99.9:0.1 to 75:25.

7. The resin particle according to claim 1, wherein the total endotherm of the crystalline resin (A) is 20 to 150 J/g.

8. The resin particle according to claim 1, wherein the crystalline resin (A) has an ester group and a urethane group.

9. The resin particle according to claim 1, wherein the crystalline resin (A) is a resin comprised solely of a crystalline part (a).

10. The resin particle according to claim 1, wherein the crystalline resin (A) is a block resin composed of a crystalline part (a) and a non-crystalline part (a′).

11. The resin particle according to claim 10, wherein the content of the crystalline part (a) contained in the resin particle is 50 to 99% by weight based on the weight of the crystalline resin (A).

12. The resin particle according to claim 9, wherein the content of the crystalline part (a) contained in the resin particle is 30 to 95% by weight based on the weight of the resin particle.

13. The resin particle according to claim 1, wherein the resin particle contains two or more kinds of the crystalline resins (A).

14. The resin particle according to claim 1, wherein the molecular weight distribution of the resin particle is 3.5 to 100.

15. A method for producing a resin particle (X) resulting from attachment of a resin particle (E) to the surface of a resin particle (G) containing a crystalline resin (A), the resin particle (X) being obtained by following a step of dispersing a solution (D) prepared by dissolving the crystalline resin (A) in an organic solvent (C) in a dispersion medium (F) containing the resin particle (E) containing a crystalline polyurethane resin (B), thereby obtaining a dispersion (DF), and then removing the organic solvent (C) and the dispersion medium (F) from the dispersion (DF), wherein the resin particle (X) is structured to have a shell layer (S) containing the crystalline polyurethane resin (B) on the surface of a core layer (Q) containing the crystalline resin (A), the maximum peak temperature (Ta) of the heat of fusion of the crystalline resin (A) is 40 to 70° C., and the maximum peak temperature (Tu) of the heat of fusion of the crystalline polyurethane resin (B) is 50 to 90° C.

16. The method for producing a resin particle (X) according to claim 15, wherein the crystalline resin (A) is obtained from its precursor (A0).

17. The method for producing a resin particle (X) according to claim 16, wherein the precursor (A0) is a combination of a prepolymer (α) having a reactive group and a curing agent (β).

18. The method for producing a resin particle (X) according to claim 15, wherein the volume average particle diameter of the resin particle (E) is 0.01 to 0.5 μm.

19. The method for producing a resin particle (X) according to claim 15, wherein the resin particle (E) has one or more members selected from the group consisting of a carboxylic acid salt group, a sulfonic acid salt group, a sulfamic acid salt group, and a phosphoric acid salt group.

20. The method for producing a resin particle (X) according to claim 19, wherein the method comprises, after a step of dispersing the solution (D) in the dispersion medium (F) in which the resin particles (E) containing the crystalline polyurethane resin (B) are dispersed, a step of converting the group or groups of one or more members selected from the group consisting of a carboxylic acid salt group, a sulfonic acid salt group, a sulfamic acid salt group, and a phosphoric acid salt group possessed by the resin particle (E) into a group or groups of one or more members selected from the group consisting of a carboxylic acid group, a sulfonic acid group, a sulfamic acid group, and a phosphoric acid group, respectively.

21. The method for producing a resin particle (X) according to claim 15, wherein the dispersion medium (F) is a non-aqueous organic solvent (F2).

22. The method for producing a resin particle (X) according to claim 15, wherein the dispersion medium (F) is an aqueous medium (F3).
